(19) United States
(12) Patent Application Publication
(10) Pub. No.: US 2014/0093820 A1
(43) Pub. Date: Apr. 3, 2014

(54) TONER FOR DEVELOPING LATENT ELECTROSTATIC IMAGE AND METHOD FOR PRODUCING TONER FOR DEVELOPING A LATENT ELECTROSTATIC IMAGE

(71) Applicants: Ayumi Satoh, Shizuoka (JP); Tsuyoshi Sugimoto, Shizuoka (JP); Akinori Saito, Shizuoka (JP); Daisuke Inoue, Shizuoka (JP); Naohiro Watanabe, Shizuoka (JP); Suzuka Amemori, Shizuoka (JP); Rintaro Takahashi, Kanagawa (JP)

(72) Inventors: Ayumi Satoh, Shizuoka (JP); Tsuyoshi Sugimoto, Shizuoka (JP); Akinori Saito, Shizuoka (JP); Daisuke Inoue, Shizuoka (JP); Naohiro Watanabe, Shizuoka (JP); Suzuka Amemori, Shizuoka (JP); Rintaro Takahashi, Kanagawa (JP)

(21) Appl. No.: 14/026,300

(22) Filed: Sep. 13, 2013

(30) Foreign Application Priority Data
Sep. 28, 2012 (JP) 2012-217617
Feb. 25, 2013 (JP) 2013-034289

(51) Int. Cl. G03G 9/08

(52) U.S. Cl. CPC G03G 9/0821; G03G 9/0804
USPC 430/113; 430/137.14

(57) ABSTRACT

To provide a toner containing toner base particles, in each of which a colorant and a releasing agent are encapsulated with a binder resin, where the toner base particles are obtained by the method containing: mixing and emulsifying a mixture containing the binder resin, the colorant, the releasing agent, and an organic solvent in an aqueous medium in the presence of resin particles, wherein the aqueous medium contains a surfactant and an inorganic salt.

### BACKGROUND OF THE INVENTION

1. Field of the Invention

The present invention relates to a toner for developing a latent electrostatic image, and a method for producing the toner.

2. Description of the Related Art

Recently, a development of an electrophotographic device aiming for energy or resource saving has been actively conducted as there are concerns for the environment. As for a toner, not only achieving high image quality, it is necessary to reduce consumed raw materials, waste materials or waste water during the production, and to fix the toner to paper without any problem even when temperature during fixing is low (low temperature fixing ability).

Conventionally, a surfactant is excessively used in production of a toner by a dissolution suspension method, as a solvent is used therein, and therefore loads are applied for treating the waste water. As an amount of the surfactant residue on a surface of the toner is increased, moreover, there is a problem in a quality that a charged amount of the toner reduces in the high temperature high humidity environment. As the amount of the surfactant for use is reduced, however, there is a problem that durability of the toner is impaired.

As one method for achieving low temperature fixing ability of a toner, a toner using a crystalline resin has been already known (see Japanese Patent Publication Application (JP-B) No. 04-024702). Although the toner using a crystalline resin has excellent low temperature fixing ability, such toner has a slight problem in shelf stability. This is because of low softening temperature of the toner due to the crystalline resin. To solve this problem, resin particles need to be efficiently deposited on the toner.

The resin particles are deposited on surfaces of toner particles to improve granulation of the toner, and to impart heat resistance and durability to the toner. When an amount of the resin particles deposited to the toner is small, sufficient heat resistance cannot be provided to the toner. When the amount of the resin particles deposited is large, on the other hand, the resin particles inhibit bleeding of wax, and therefore offset may occur.

As for a conventional technique using aggregation salt (see Japanese Patent Application Laid-Open (JP-A) Nos. 2009-145747 and 2006-178407), uniform aggregations of different particles have been achieved in toner production in accordance with an emulsified aggregation method. However, a method for efficiently depositing certain particles on surfaces of toner particles in one step has not been known.

### SUMMARY OF THE INVENTION

The present invention aims to provide a toner having excellent storage stability, durability, low temperature fixing ability, and charging ability, which is obtained by a method for forming toner base particles, in each of which a colorant and a releasing agent are encapsulated with a binder resin, where the method contains mixing and emulsifying a mixture containing the binder resin, the colorant, the releasing agent, and an organic solvent, in an aqueous medium in the presence of resin particles.

As the means for solving the aforementioned problems, the toner of the present invention contains:

toner base particles, in each of which a colorant and a releasing agent are encapsulated with a binder resin, where the toner base particles are obtained by the method containing:

mixing and emulsifying a mixture containing the binder resin, the colorant, the releasing agent, and an organic solvent in an aqueous medium in the presence of resin particles,

wherein the aqueous medium contains a surfactant and an inorganic salt.

The present invention can solve the aforementioned problems in the art, and can provide a toner having excellent stability, durability, low temperature fixing ability, and charging ability,

### BRIEF DESCRIPTION OF THE DRAWINGS

FIG. 1 is a schematic explanatory diagram illustrating a structural example of one embodiment of the image forming apparatus.

FIG. 2 is a schematic explanatory diagram illustrating a structural example of another embodiment of the image forming apparatus.

FIG. 3 is a schematic explanatory diagram illustrating a structural example of yet another embodiment of the image forming apparatus (tandem color image forming apparatus).

FIG. 4 is a partially enlarged schematic explanatory diagram of the image forming apparatus illustrated in FIG. 3.

FIG. 5 is a schematic explanatory diagram illustrating a structural example of the fixing device used in Examples.

### DETAILED DESCRIPTION OF THE INVENTION

The present inventors have diligently conducted studies to solve the aforementioned problems, and as a result, they have attained the following insights.

That is, resin particles are effectively deposited to a toner by adding a surfactant and an inorganic salt to an aqueous medium to thereby impart heat resistant and durability to the toner, which is produced by a toner base particle production method, which contains: mixing a mixture containing at least a binder resin, a colorant, a releasing agent, and an organic solvent, with an aqueous medium in the presence of the resin particles, to thereby emulsify to produce toner base particles in each of which at least the colorant and the releasing agent are encapsulated in a binder resin.

The inorganic salt can act on oil droplets (dispersed elements each composed of a solution or dispersion liquid of the aforementioned toner materials) in a mixed liquid, as well as the resin particles, to change a salt concentration, adjust a thickness of an electric double layer, or to adjust an adsorption concentration of the surfactant, as the inorganic salt is dissolved in the aqueous medium in advance. Therefore, an interaction between the oil droplets and the resin particles is adjusted by adding the surfactant and the inorganic salt to the aqueous medium, and therefore it is possible to effectively deposit the resin particles onto surfaces of the oil droplets. Furthermore, by producing a toner by a so-called dissolution suspension method, resin particles can be strongly deposited onto surfaces of the toner particles, to thereby significantly improve durability of the toner.

Accordingly, the toner for developing a latent electrostatic image of the present invention contains toner base particles, in each of which a colorant and a releasing agent are encapsulated with a binder resin, where the toner base particles are obtained by the method containing: mixing and emulsifying a mixture containing the binder resin, the colorant, the releasing agent, and an organic solvent in an aqueous medium in the presence of resin particles, wherein the aqueous medium contains a surfactant and an inorganic salt.

The toner for developing a latent electrostatic image and the method for producing the same according to the present invention are explained in details next.

Note that, the embodiment described below is a preferable embodiment of the present invention and therefore various technically preferable limitations are added thereto. However, the scope of the present invention is not limited to these embodiments unless there is a description otherwise.

### —Toner for Developing Latent Electrostatic Image and Production Method Thereof—

The method for producing base particles of the toner of the present invention contains: mixing and emulsifying a mixture containing a binder resin, a colorant, a releasing agent, and an organic solvent in an aqueous medium in the presence of resin particles to emulsify, to thereby produce toner base particles in each of which at least the colorant, and the releasing agent are encapsulated in the binder resin, wherein at least an inorganic salt is added to the aqueous medium together with a surfactant.

The base particles of the toner for developing a latent electrostatic image (may merely referred to as a “toner” hereinafter) of the present invention are obtained by the method for producing a toner for developing a latent electrostatic image of the present invention.

As for a preferable embodiment of base particles of the toner for developing a latent electrostatic image of the present invention, a mixture containing at least a binder resin containing at least a crystalline resin, a colorant, a releasing agent, and an organic solvent with an aqueous medium in the presence of resin particles to emulsify, to thereby form toner base particles in each of which at least the colorant and the releasing agent are encapsulated in the binder resin, in which at least a surfactant and an inorganic salt are added to the aqueous medium.

The details of the toner of the present invention are explained through the descriptions of the method for producing a toner of the present invention, hereinafter.

### —Toner Material Solution or Dispersion Liquid—

The toner material solution or dispersion liquid is formed by dissolving or dispersing the toner materials in a solvent.

The toner materials are appropriately selected depending on the intended purpose without any limitation, provided that the toner materials contain a binder resin, a colorant, and a releasing agent, and can form a toner. For example, the toner materials contain at least a monomer or a polymer for constituting a binder resin, preferably contain a crystalline resin, and may further contain other components, such as a charge controlling agent, if necessary.

It is preferred that the solvent in which the toner materials are dissolved or dispersed be an organic solvent, and the organic solvent be removed from the emulsion or dispersion liquid after the mixing.

The organic solvent is appropriately selected depending on the intended purpose without any limitation, provided that it is a solvent capable of dissolving and/or dispersing the toner material therein. In view of easiness of removal, the organic solvent is preferably a volatile organic solvent having a boiling point of lower than 150° C. Examples thereof include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, and methyl isobutyl ketone. Among them, an ester-based solvent is preferable, and ethyl acetate is particularly preferable. These may be used alone, or in combination.

An amount of the organic solvent for use is appropriately selected depending on the intended purpose without any limitation, and for example, the amount thereof is preferably 40 parts by mass to 300 parts by mass, more preferably 60 parts by mass to 140 parts by mass, and even more preferably 80 parts by mass to 120 parts by mass, relative to 100 parts by mass of the toner material.

### —Aqueous Medium—

The aqueous medium is appropriately selected from those known in the art without any limitation, and examples thereof include water, a solvent miscible with water, and a mixture thereof. Among them, water is particularly preferable.

The solvent miscible with water is not particularly limited, as long as it is miscible with water, and examples thereof include alcohol, dimethyl formamide, tetrahydrofuran, cellosolve, and lower ketone.

Examples of the alcohol include methanol, isopropanol, and ethylene glycol. Examples of the lower ketone include acetone, and methyl ethyl ketone.

These may be used alone, or in combination, and the organic solvent may be used at the solubility thereof or lower.

The aqueous medium contains therein resin particles.

By adding particles, especially resin particles, into the aqueous medium in a dispersed state, toner particles having excellent charging ability and uniform particle size distribution can be attained.

The particles are appropriately selected depending on the intended purpose without any limitation, provided that they are particles present as solids, which are insoluble to water, in the aqueous medium, but the particles are preferably particles having the average particle diameter of 0.01 μm to 1 μm.

Examples of organic particles (resin particles) among the aforementioned particles include microcrystals of a low molecular organic compound.

As for the relationship in the size between the toner base particles and the particles deposited on surfaces of the toner base particles, the following relationship is satisfied:

5≦R/Rs≦2,000

In the relational expression above, R is a diameter of a toner base particle, and Rs is a diameter of the particle. Preferably, R and Rs satisfy 20≦R/Rs≦200. When the R and Rs are outside the aforementioned numerical range, an effect of the particles to control the particle size of the toner may be significantly impaired.

Moreover, an amount of the particles deposited on surfaces of the toner base particles is appropriately selected depending on the intended purpose without any limitation, and for example, the lower limit thereof is preferably 0.1% by mass, more preferably 0.5% by mass, and even more preferably 1% by mass relative to the toner base particles, and the upper limit thereof is preferably 20% by mass, more preferably 10% by mass, and even more preferably 5% by mass relative to the toner base particles.

In view of control of a particle size of the toner base particles, the volume average particle diameter (Dv) of the particles preferably satisfies the relationship of 5 μm≦Dv≦500 μm, more preferably satisfies the relationship of 50 μm≦Dv≦200 μm.

The particle size distribution (volume average particle diameter (Dv)/number average particle diameter (Dn)) of the particles is preferably less than 1.25. Use of the particles having such particle size distribution can attain a toner having a sharp particle size distribution. As for the particles, resin particles described below can be suitably used.

Among the particles, examples of inorganic particles include silica, alumina, titanium oxide, barium titanate, magnesium titanate, calcium titanate, strontium titanate, zinc oxide, tin oxide, quartz sand, clay, mica, wollastonite, diatomaceous earth, chromic oxide, cerium oxide, red iron oxide, antimony trioxide, magnesium oxide, zirconium oxide, barium sulfate, barium carbonate, calcium carbonate, silicon carbide, and silicon nitride.

Moreover, preferable examples thereof include tricalcium phosphate, calcium carbonate, colloidal titanium oxide, colloidal silica, and hydroxyapatite.

These may be used alone, or in combination. Among them, hydroxyapatite synthesized through a reaction between sodium phosphate and calcium chloride in water under basic conditions is particularly preferable.

### —Emulsification or Dispersion—

The toner material solution or dispersion liquid is emulsified or dispersed in the aqueous medium to thereby prepare an emulsion or dispersion liquid. As a result of the preparation of the emulsion or dispersion liquid, dispersed elements (oil droplets) composed of the toner material solution or dispersion liquid are formed in the aqueous medium.

The toner material solution or dispersion liquid is preferably emulsified or dispersed in the aqueous medium with stirring.

The method for the dispersing is appropriately selected using a conventional disperser without any limitation. The method thereof may be a batch system or a continuous system. Examples of the disperser include a low-speed shearing disperser, a high-speed shearing disperser, a friction disperser, a high-pressure jetting disperser and ultrasonic wave disperser. Among them, a disperser of a continuous system is preferable in view of productivity, and a high-speed shearing disperser is preferable as it can control the diameters of the dispersed elements (oil droplets) to the range of 2 μm to 20 μm.

In the case where the high-speed shearing disperser is used, the conditions thereof, such as the rotating speed, dispersion time, and dispersion temperature, are appropriately selected depending on the intended purpose without any limitation. For example, the rotating speed thereof is preferably 1,000 rpm to 30,000 rpm, more preferably 5,000 rpm to 20,000 rpm. In case of the batch system, the dispersion time thereof is preferably 0.1 minutes to 5 minutes. The dispersion temperature thereof is preferably 0° C. to 150° C. in the pressurized state, more preferably 40° C. to 98° C. Note that, the dispersing is typically easily carried out when the dispersion temperature is high.

A dispersant is preferably used in the emulsifying or dispersing, if necessary, for the purpose of attaining a sharp particle size distribution, and stably carrying out dispersing.

The dispersant is appropriately selected depending on the intended purpose without any limitation, and examples thereof include a surfactant, a water-insoluble inorganic compound dispersant, and polymeric protective colloid. These may be used alone, or in combination. Among them, a surfactant is preferable.

Examples of the surfactant include an anionic surfactant, a cationic surfactant, a nonionic surfactant, and an amphoteric surfactant. Among them, the anionic surfactant is preferable.

Examples of the anionic surfactant include alkyl benzene sulfonate, α-olefin sulfonic acid salt, phosphoric acid ester, and alkyl carboxylic acid salt. As for the anionic surfactant, alkyl sulfate, alkyl sulfonate, and alkyl benzene sulfonate, such as the ones represented by the following formulae (1) to (4), are particularly preferable.

CₙH₂ₙ₊₁—O—R—SO₃⁻M⁺ Formula (1)

CₙH₂ₙ₊₁—O—R(SO₃⁻M⁺)—O—R—SO₃⁻M⁺ Formula (2)

CₙH₂ₙ₊₁—O—SO₃⁻M⁺ Formula (3)

CₙH₂ₙ₊₁—SO₃⁻M⁺ Formula (4)

(n=10 to 18, R═Ar, M is a monovalent metal)

An amount of the anionic surfactant for use is appropriately selected depending on the intended purpose without any limitation. For example, the amount of the anionic surfactant is preferably 0.1% by mass to 4.5% by mass, more preferably 0.1% by mass to 3.0% by mass, even more preferably 0.2% by mass to 2.5% by mass, and particularly preferably 0.3% by mass to 1.3% by mass, relative to the aqueous medium.

When the amount of the surfactant for use is large, charging characteristics of a resulting toner are impaired, and environmental load from the production of the toner increases.

Although a precise reason is not clear, the durability of a resulting toner is impaired, when the amount of the surfactant for use is small. When the amount of the surfactant is small, moreover, it has been known that a storage stability of a resulting toner is impaired if the crystalline resin is contained in the binder resin.

The present inventors conducted diligent studies to the aforementioned problems to be solved by the present invention. As a result, it has been found that the resin particles are not deposited on the surfaces of the toner particles when an amount of a surfactant is small. Moreover, it has been found that the resin particles are effectively deposited by adding an inorganic salt into the aqueous medium. An assumed mechanism for this is as follow. An interaction between oil droplets and resin particles can be controlled by adding a surfactant to the aqueous medium together with an inorganic salt, and as a result, it is possible to effectively deposit the resin particles onto surfaces of the oil droplets.

Examples of the cationic surfactant include an amine salt-based surfactant, and a quaternary ammonium salt-based cationic surfactant. Examples of the amine salt-based surfactant include an alkyl amine salt, an amino alcohol fatty acid derivative, a polyamine fatty acid derivative, and imidazoline. Examples of the quaternary ammonium salt-based cationic surfactant include an alkyl trimethyl ammonium salt, a dialkyl dimethyl ammonium salt, an alkyl dimethyl benzyl ammonium salt, a pyridinium salt, an alkyl isoquinolinium salt and benzethonium chloride.

Examples of the nonionic surfactant include a fatty acid amide derivative, and a polyhydric alcohol derivative.

Examples of the amphoteric surfactant include alanine, dodecyldi(aminoethyl)glycine, di(octylaminoethyl)glycine and N-alkyl-N,N-dimethylammonium betaine.

Examples of the water-insoluble inorganic compound dispersant include tricalcium phosphate, calcium carbonate, titanium oxide, colloidal silica and hydroxyapatite.

The polymeric protective colloid is appropriately selected depending on the intended purpose without any limitation, and examples thereof include: acid, such as acrylic acid, methacrylic acid, α-cyanoacrylic acid, α-cyanomethacrylic acid, itaconic acid, crotonic acid, fumaric acid, maleic acid and maleic anhydride; (meth)acryl monomer containing a hydroxyl group, such as β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloroaniline-2-hydroxypropyl acrylate, 3-chloroaniline-2-hydroxypropyl methacrylate, diethylene glycol monoacrylate, diethylene glycol monomethacrylate, glycerin monoacrylate, glycerin monomethacrylate, N-methylol acryl amide, and N-methylol methacryl amide; vinyl alcohol or ether with vinyl alcohol, such as vinyl methyl ether, vinyl ethyl ether, and vinyl propyl ether; ester of vinyl alcohol and a compound containing a carboxyl group, such as vinyl acetate, vinyl propionate, and vinyl butyrate; acryl amide, such as acryl amide, methacryl amide, diacetone acryl amide, and methylol compounds thereof; acid chloride, such as acrylic acid chloride, and methacrylic acid chloride; a homopolymer or copolymer containing a nitrogen atom or its heterocycle, such as vinyl pyridine, vinyl pyrrolidone, vinyl imidazole, and ethylene imine; polyoxyethylene, such as polyoxy ethylene, polyoxypropylene, polyoxy ethylene alkyl amine, polyoxypropylene alkyl amine, polyoxyethylene alkyl amide, polyoxypropylene alkyl amide, polyoxyethylene nonylphenyl ether, polyoxyethylene laurylphenyl ether, polyoxyethylene stearylphenyl ester, and polyoxyethylene nonylphenyl ester; and cellulose, such as methyl cellulose, hydroxyethyl cellulose, and hydroxypropyl cellulose.

### —Mixing—

As a first embodiment, the mixing is preferably carried out by adding either an aqueous medium or a solid-containing dispersion liquid into the emulsion or dispersion liquid.

As a second embodiment, the mixing is preferably carried out by adding the emulsion or dispersion liquid into either an aqueous medium or a solid-containing dispersion liquid.

Note that, in the case where a main purpose is to inhibit unification or aggregation of oil droplets (dispersed elements composed of the toner material solution or dispersion liquid) in the emulsion or dispersion liquid at the time of mixing, use of the aqueous medium is more preferable than the solid-containing dispersion liquid.

In the case where the mixing is continuously performed at a constant rate, for example, there is a method, in which a pipe through which the aqueous medium or the solid-containing dispersion liquid is passed through is provided into a pipe through which the emulsion or dispersion liquid is passed through, and mixing is carried out continuously at a constant rate. In this case, however, there are problems that mixing may not be homogeneously performed, a flow inside the pipe may be disturbed as one pipe is mounted into another pipe, and it is difficult to control an amount of the liquid to be mixed over time. Accordingly, the mixing is preferably carried out by adding one liquid to another liquid.

### —Aqueous Medium Used for Mixing—

The aqueous medium used for the mixing is appropriately selected depending on the intended purpose without any limitation, for example, the aqueous medium preferably contains water as a main component. The main component means that such component occupies 75% by mass or greater based on the mass ratio.

The aqueous medium used for the mixing preferably contains the organic solvent at the saturated concentration or lower. The organic solvent is dissolved in the aqueous medium of the emulsion or dispersion liquid at the saturate concentration or lower. In the case where the aqueous medium to be added does not contain the organic solvent, the organic solvent is diffused into the aqueous medium from the oil droplets, and therefore the stability of the oil droplets may be impaired, as the resin is concentrated, or the pigment or wax is aggregated at an interface of the oil droplet. Accordingly, the diffusion of the organic solvent can be prevented by adding the organic solvent into the aqueous medium.

The aqueous medium used for the mixing contains an inorganic salt. By dissolving the inorganic salt in the emulsion or dispersion liquid in advance, the salt concentration is controlled, a thickness of an electric double layer is controlled, or the adsorption concentration of the dispersant is controlled to thereby enhance the stability of the oil droplets. As a result, a structure inside a particle is uniform, and a crosslink or elongation reaction is smoothly progressed.

The inorganic salt is appropriately selected depending on the intended purpose without any limitation, and examples thereof include chloride, nitrate, sulfate, and carbonate of Na, K, Ca, etc. These may be used alone, or in combination.

An amount of the inorganic salt for use is appropriately selected depending on the intended purpose without any limitation, but the inorganic salt is preferably used in an amount of 0.01% by mass to 20% by mass relative to the aqueous medium.

Optionally, a dispersant is preferably used in the aqueous medium used for the mixing in order to stabilize the dispersed elements (oil droplets each composed of the toner material solution or dispersion liquid) and to attain particles of the desirable shapes and a sharp particle size distribution.

The dispersant is appropriately selected depending on the intended purpose without any limitation, and examples thereof include a surfactant, a water-insoluble inorganic compound dispersant, polymeric protective colloid, and organic resin particles. These may be used alone, or in combination. Among them, a surfactant is preferable, as the surfactant can prevent the particles formed by uniting the oil droplets from further unification, and can help to form stable particles. —Solid-Containing Dispersion Liquid—

The solid-containing dispersion liquid used for the mixing is obtained by removing the solvent from the emulsion or dispersion liquid.

The solid-containing dispersion liquid is appropriately selected depending on the intended purpose without any limitation, but the formulation of the particles contained in the solid-containing dispersion liquid is preferably the same as the formulation of the particles contained in the emulsion or dispersion liquid to be mixed.

An amount of the solids (particles) in the solid-containing dispersion liquid is preferably 50% by mass or less, more preferably 10% by mass or greater but less than 25% by mass. When the amount of the solids is greater than 50% by mass, the particles contained in the solid-containing dispersion liquid come close to each other, which may cause unification or aggregation with unstable oil droplets contained in the emulsion or dispersion liquid to be mixed. In view of inhibition of unification or aggregation of the oil droplets, and productivity of the emulsion or dispersion liquid, the amount thereof is preferably 10% by mass or greater but less than 25% by mass.

In the first embodiment of the mixing, the mixing is preferably carried out by adding 5% by volume to 100% by volume of the aqueous medium or the solid-containing dispersion liquid relative to a total amount of the emulsion or dispersion liquid, more preferably adding 5% by volume to 50% by volume thereof, and even more preferably adding 10% by volume to 30% by volume thereof.

Dispersed elements (oil droplets) composed of the toner material solution or dispersion liquid can be stably formed by adding the aqueous medium or the solid-containing dispersion liquid. Specifically, after the emulsifying or dispersing, oil droplets formed with the desirable particle diameters are prevented from combining each other to form large particles, to thereby achieve formation of small particles, and particles having the desirable particle diameters can be formed by combining fine oil droplets, which do not meet the desirable particle diameters. As a result, the particle size distribution can be made sharp.

When the amount of the aqueous medium or solid-containing dispersion liquid to be added is less than 5% by volume, formation of large size oil droplets may not be sufficiently prevented. When the amount thereof is greater than 100% by volume, an effect of preventing formation of large size oil droplets is sufficient, but a total amount of the mixed liquid becomes large, and as a result, operations after the mixing may becomes more complicated.

It is preferred that either the aqueous medium or the solid-containing dispersion liquid be added just after the preparation of the emulsion or dispersion liquid. By adding the aqueous medium just after the preparation of the dispersion liquid, unification or cohesion of the oil droplets caused due to instability thereof with time is prevented, to thereby produce a toner having a sharp particle size distribution.

The term “just after the preparation” means the period at least before particle diameters of oil droplets become 2.0 μm or greater. As for the addition thereof just after the preparation of the emulsion or dispersion liquid, it is preferably performed within 30 minutes after stopping applying the shearing force or dispersion force in the course of the preparation of the emulsion or dispersion liquid, and is more preferably performed within 10 minutes.

The speed for adding the aqueous medium is appropriately selected depending on the intended purpose without any limitation. For example, the entire amount of the aqueous medium is preferably added within 10 minutes to 200 minutes, more preferably 20 minutes to 60 minutes.

The addition of either the aqueous medium or the solid-containing dispersion liquid is preferably performed with stirring the emulsion or dispersion liquid. By the stirring, the aqueous medium or the solid-containing dispersion liquid is promptly mixed with the emulsion or dispersion liquid, to thereby prevent formation of large particles. During this operation, it is preferred that the aqueous medium or solid-containing dispersion liquid be added along the wall surface so as not to splash, and the adding speed be controlled slow.

The method of the stirring is appropriately selected depending on the intended purpose without any limitation, and for example, it is performed using any of the aforementioned conventional dispersers.

The stirring speed of the dispersion liquid is appropriately selected depending on the intended purpose without any limitation, but it is preferably 1,000 rpm to 30,000 rpm, more preferably 5,000 rpm to 20,000 rpm.

In the first embodiment of the mixing, the preparation of the emulsion or dispersion liquid and the mixing are preferably carried out in the same tank. Accordingly, the preparation of the emulsion or dispersion liquid is preferably performed in a batch system. In the batch system, the aqueous medium or the solid-containing dispersion liquid can be added with stirring or dispersing in a container or tank in which the emulsion or dispersion liquid is prepared, and therefore the same container or tank can be used.

Note that, in the case where the preparation of the emulsion or dispersion liquid is continuously performed, a method containing continuously adding the aqueous medium or the solid-containing dispersion liquid to the emulsion or dispersion liquid at the predetermined ratio to mix, or a method, in which a tank is filled with the emulsion or dispersion liquid, and the aqueous medium or the solid-containing dispersion liquid is fed into the emulsion or dispersion liquid from the bottom part of the tank, can be used.

In the second embodiment of the mixing, the organic solvent is preferably removed after adding the emulsion or dispersion liquid into the aqueous medium or the solid-containing dispersion liquid. In this case, oil droplets are prevented from being combined to form large particles until the time when the organic solvent is removed, formation of small particles can be achieved, and the particle size distribution can be made sharp.

Moreover, the mixing is preferably carried out by adding the emulsion or dispersion liquid with stirring the aqueous medium or the solid-containing dispersion liquid. The stirring prevents disproportionation of the mixed solution due to the volume of the container, or time lapse of the mixing (particularly initial stage of the mixing), to thereby prevent formation of large oil droplets.

As for the method of the stirring, the same method to that in the first embodiment of the mixing can be used.

When the organic solvent is removed, the emulsion or dispersion liquid is retained in a container, such as a tank, and the emulsion or dispersion liquid is stood substantially still from when the retention of the emulsion or dispersion liquid is started to when stirring is started by stirring wings. Therefore, the oil droplets tend to be combined together to form coarse particles. However, if the aqueous medium or the solid-containing dispersion liquid is placed in a container in advance, and the emulsion or dispersion liquid is added thereto with stirring the aqueous medium or the solid-containing dispersion liquid, the time period until the stirring of the added emulsion or dispersion liquid is started is shortened, and the stirring is performed just after the retention is started. Therefore, unification of the oil droplets can be prevented.

As described above, it is preferred that the aqueous medium or the solid-containing dispersion liquid be retained in a container in advance, and the emulsion or dispersion liquid be added to the retained aqueous medium or solid-containing dispersion liquid.

As for the retention, a liquid added in advance is not preferably discharged from a container of the system (including inside a tank, pipes) when the emulsion or dispersion liquid is added. Even when the liquid is discharged, however, an amount of the liquid discharged per unit time is less than 10% by mass relative to the emulsion or dispersion liquid to be added into the tank is recognized as a substantially retained state.

The retained amount of the aqueous medium or the solid-containing dispersion liquid is appropriately selected depending on the intended purpose without any limitation, but it is preferably 0.1% to 50%, more preferably 1.0% to 30%, and even more preferably 5% to 20%, relative to the volume of the container.

When the retained amount thereof is less than 0.1% of the volume of the container, the retained aqueous medium or solid-containing dispersion liquid is scattered in the container by the stirring performed by the stirring wing, and therefore it may became an insufficient amount to be mixed with the emulsion or dispersion liquid to be added. When the retained amount thereof is greater than 50%, it may exceed an appropriate amount in view of the production efficiency.

In the second embodiment of the mixing, the preparation of the emulsion or dispersion liquid is preferably carried out in a continuous system. In the continuous system, the emulsion or dispersion liquid, which will be unstable with time, is produced at a certain rate. There is no problem if the following step is performed in a continuous system. In the case where the following steps, such as the removal of the solvent, washing, and filtering, are performed in a batch system, however, it is necessary to maintain the prepared emulsion or dispersion liquid in a stable state. Therefore, the continuous system is particularly preferable for the second embodiment of the mixing.

The solid-containing dispersion liquid retained in the container in advance is appropriately selected depending on the intended purpose without any limitation, and examples thereof include a solid-containing dispersion liquid separately produced, and a solid containing dispersion liquid produced using the same equipment in advance. A preferable embodiment is carrying out a process in the container, leaving part of the liquid previously processed in the container, and adding a new batch of the emulsion or dispersion liquid.

A concentration of the organic solvent in the solid-containing dispersion liquid retained in the container is preferably 200% or lower relative to the organic solvent concentration (mass relative to water) of the emulsion or dispersion liquid to be added.

Note that, various additives, such as acid, base, a coagulating agent, and particles, may be dissolved or dispersed in the aqueous medium or solid-containing dispersion liquid retained in the container.

In the production method of the toner of the present invention, a method for granulating a toner is appropriately selected from conventional methods without any limitation, and examples thereof include: a method for granulating a toner using a dissolution suspension method, and a method for granulating a toner while generating an adhesive base, which is described later. Among them, the method for granulating a toner while generating the adhesive base is preferable.

The toner obtained by granulation in accordance with the conventional method contains a colorant, a releasing agent, and a binder resin, preferably further contain a crystalline polyester resin, and may further contain appropriately selected other components, such as a charge controlling agent, if necessary.

The method for granulating a toner white generating the adhesive base is carried out by allowing an active hydrogen group-containing compound and a polymer reactable with the active hydrogen group-containing compound of the toner materials to react to thereby generating an adhesive base, and forming particles each containing at least the adhesive base.

The toner formed using the aforementioned granulation method preferably contains a colorant, a releasing agent, and a crystalline polyester resin, and may further contain appropriately selected other components, such as a charge controlling agent, if necessary. The toner is obtained by dissolving or dispersing toner materials containing at least an active hydrogen group-containing compound and a polymer reactable with the active hydrogen group-containing compound in an organic solvent to prepare a toner material solution or dispersion liquid, emulsifying or dispersing the solution or dispersion liquid in an aqueous medium to prepare an emulsion or dispersion liquid, mixing the emulsion or dispersion liquid with either an aqueous medium or a solid-containing dispersion liquid obtained by removing the solvent from the emulsion or dispersion liquid, and allowing the active hydrogen group-containing compound and the polymer reactable with the active hydrogen group-containing compound to react in the aqueous medium, to thereby generate particles each containing at least an adhesive base.

### —Adhesive Base—

The adhesive base exhibits adhesion to a recording medium, such as paper, and contains at least an adhesive polymer obtained by allowing the active hydrogen group-containing compound and a polymer reactable with the active hydrogen group-containing compound in the aqueous phase, and may further contain a binder resin appropriately selected from conventional binder resins.

The weight average molecular weight of the adhesive base is appropriately selected depending on the intended purpose without any limitation, but it is, for example, preferably 3,000 or greater, more preferably 5,000 to 1,000,000, and even more preferably 7,000 to 500,000.

When the weight average molecular weight thereof is smaller than 3,000, hot offset resistance of a resulting toner may be impaired.

The glass transition temperature (Tg) of the adhesive base is appropriately selected depending on the intended purpose without any limitation, but it is, for example, preferably 30° C. to 70° C., more preferably 40° C. to 65° C. As the polyester resin obtained through an elongation reaction is present together with the adhesive base in the toner, the toner exhibits excellent storage stability with low glass transition temperature, compared to a conventional polyester-based toner.

When the glass transition temperature (Tg) is lower than 30° C., heat resistant storage stability of a resulting toner may be impaired. When the glass transition temperature (Tg) thereof is higher than 70° C., low temperature fixing ability of a resulting toner may not be sufficient.

The glass transition temperature can be measured in the following method using, for example, TG-DSC System TAS-100 (manufactured by Rigaku Corporation). First, an aluminum sample container was charged with about 10 mg of the toner, the sample container is placed on a holder unit, and then set in an electric furnace. After heating the sample from the room temperature to 150° C. at the heating rate of 10° C./min, the sample was left for 10 minutes at 150° C. The sample was then cooled to the room temperature, and left to stand for 10 minutes. Thereafter, the sample was heated to 150° C. in the nitrogen atmosphere at the heating rate of 10° C./min, to measure a DSC curve thereof by a differential scanning calorimeter (DSC). Using the obtained DSC curve and the analysis system of TG-DSC System TAS-100, the glass transition temperature (Tg) can be calculated from the contact point between the tangent line of the endothermic curve adjacent to the glass transition temperature (Tg) and the base line.

Specific examples of the adhesive base are appropriately selected depending on the intended purpose without any limitation, but a polyester-based resin is particularly preferable as the adhesive base.

The polyester-based resin is appropriately selected depending on the intended purpose without any limitation. For example, a urea-modified polyester-based resin is particularly preferable as the polyester-based resin.

The urea-modified polyester-based resin is obtained by reacting amine (B) serving as the active hydrogen group-containing compound with isocyanate group-containing polyester prepolymer (A) serving as a polymer reactable with the active hydrogen group-containing compound, in the aqueous phase.

The urea-modified polyester-based resin may contain, in addition to a urea bond, a urethane bond. In this case, a molar ratio (urea bond/urethane bond) of the urea bond to the urethane bond is appropriately selected depending on the intended purpose without any limitation, but it is preferably 100/0 to 10/90, more preferably 80/20 to 20/80, and even more preferably 60/40 to 30/70.

When the ratio of the urea bond is less than 10, hot offset resistance of a resulting toner may be impaired.

Preferable specific examples of the urea-modified polyester resin include the following (1) to (10):

(1) a mixture containing: a compound obtained through ureation of polyester prepolymer with isophorone diamine, where the polyester prepolymer is obtained through a reaction of a polycondensation product between a bisphenol A ethylene oxide (2 mol) adduct and isophthalic acid with isophorone diisocyanate; and a polycondensation product between a bisphenol A ethylene oxide (2 mol) adduct and isophthalic acid;
(2) a mixture containing a compound obtained through ureation of a polyester prepolymer with isophorone diamine, where the polyester prepolymer is obtained through a reaction of a polycondensation product between a bisphenol A ethylene oxide (2 mol) adduct and isophthalic acid with isophorone diisocyanate; and a polycondensation product between a bisphenol A ethylene oxide (2 mol) adduct and terephthalic acid;
(3) a mixture containing: a compound obtained through ureation of a polyester prepolymer with isophorone diamine, where the polyester prepolymer is obtained through a reaction of a polycondensation product between a bisphenol A ethylene oxide (2 mol) adduct/bisphenol A propylene oxide (2 mol) adduct with terephthalic acid; and a polycondensate between bisphenol A ethylene oxide (2 mol) adduct/bisphenol A propylene oxide (2 mol) adduct and terephthalic acid;
(4) a mixture containing a compound obtained through ureation of a polyester prepolymer with isophorone diamine where the polyester prepolymer is obtained through a reaction of a polycondensation product between a bisphenol A ethylene oxide (2 mol) adduct/bisphenol A propylene oxide (2 mol) adduct and terephthalic acid with isophorone diisocyanate; and a polycondensation product between a bisphenol A propylene oxide (2 mol) adduct and terephthalic;
(5) a mixture containing: a compound obtained through ureation of a polyester prepolymer with hexamethylene diamine, where the polyester prepolymer is obtained through a reaction of a polycondensation product between a bisphenol A ethylene oxide (2 mol) adduct and terephthalic acid with isophorone diisocyanate; and a polycondensation product between a bisphenol A ethylene oxide (2 mol) adduct and terephthalic acid;
(6) a mixture containing: a compound obtained through ureation of a polyester prepolymer with hexamethylene diamine, where the polyester prepolymer is obtained through a reaction of a polycondensation product between a bisphenol A ethylene oxide (2 mol) adduct and terephthalic acid with isophorone diisocyanate; and a polycondensation product between a bisphenol A ethylene oxide (2 mol) adduct/bisphenol A propylene oxide (2 mol) adduct and terephthalic acid;
(7) a mixture containing: a compound obtained through ureation of a polyester prepolymer with ethylene diamine, where the polyester prepolymer is obtained through a reaction of a polycondensation product between a bisphenol A ethylene oxide (2 mol) adduct and terephthalic acid with isophorone diisocyanate; and a polycondensation product between a bisphenol A ethylene oxide (2 mol) adduct and terephthalic acid;
(8) a mixture containing: a compound obtained through ureation of a polyester prepolymer with hexamethylene diamine, where the polyester prepolymer is obtained through a reaction of a polycondensation product between a bisphenol A ethylene oxide (2 mol) adduct and isophthalic acid with diphenyl methane diisocyanate; and a polycondensation product between a bisphenol A ethylene oxide (2 mol) adduct and isophthalic acid;
(9) a mixture containing: a compound obtained through ureation of a polyester prepolymer with hexamethylene diamine, where the polyester prepolymer is obtained through a reaction of a polycondensation product between bisphenol A ethylene oxide (2 mol) adduct/bisphenol A propylene oxide (2 mol) adduct and terephthalic acid/dodecenyl succinic acid anhydride with diphenylmethane diisocyanate; and a polycondensation product between a bisphenol A ethylene oxide (2 mol) adduct/bisphenol A propylene oxide (2 mol) adduct and terephthalic acid; and
(10) a mixture containing a compound obtained through ureation of a polyester prepolymer with hexamethylene diamine, where the polyester prepolymer is obtained through a reaction of a polycondensation product between a bisphenol A ethylene oxide (2 mol) adduct and isophthalic acid with toluene diisocyanate; and a polycondensation product between a bisphenol A ethylene oxide (2 mol) adduct and isophthalic acid.

### —Active Hydrogen Group-Containing Compound—

The active hydrogen group-containing compound functions as an elongation agent or crosslinking agent, when a polymer reactable with the active hydrogen group-containing compound is allowed to carry out an elongation reaction or crosslink reaction in the aqueous medium.

The active hydrogen group-containing compound is appropriately selected depending on the intended purpose without any limitation, provided that it contains an active hydrogen group. In the case where a polymer reactable with the active hydrogen group-containing compound is the isocyanate group-containing polyester prepolymer (A), for example, the active hydrogen group-containing compound is preferably the amine (B) because it can produce a polyester-based resin having a high molecular weight through a reaction, such as an elongation reaction, and a crosslink reaction, with the isocyanate group-containing polyester prepolymer (A).

The active hydrogen group is appropriately selected depending on the intended purpose without any limitation, and examples thereof include a hydroxyl group (alcoholic hydroxyl group, or phenolic hydroxyl group), an amino group, a carboxyl group, and a mercapto group. These may be used alone, or in combination. Among them, an alcoholic hydroxyl group is particularly preferable.

The amine (B) is appropriately selected depending on the intended purpose without any limitation, and examples thereof include diamine (B1), trivalent or higher polyamine (B2), aminoalcohol (B3), aminomercaptan(B4), amino acid (B5), and a blocked product (B6) in which an amino group of any of B1 to B5 is blocked.

These may be used alone, or in combination. Among them, diamine (B 1), and a mixture containing diamine (B 1) and a small amount of trivalent or higher polyamine (B2) are particularly preferable.

Examples of the diamine (B 1) include aromatic diamine, alicyclic diamine, and aliphatic diamine. Examples of the aromatic diamine include phenylene diamine, diethyltoluene diamine, and 4,4′-diaminodiphenyl methane. Examples of the alicyclic diamine include 4,4′-diamino-3,3′-dimethyldicylohexyl methane, diamine cyclohexane, and isophorone diamine. Examples of the aliphatic diamine include ethylene diamine, tetramethylene diamine, and hexamethylene diamine.

Examples of the trivalent or higher polyamine (B2) include diethylene triamine, and triethylene tetramine.

Examples of the aminoalcohol (B3) include ethanol amine, and hydroxyethyl aniline.

Examples of the aminomercaptan (B4) include aminoethylmercaptan, and aminopropylmercaptan.

Examples of the amino acid (B5) include aminopropionic acid, and aminocaproic acid.

Examples of the blocked product (B6) in which an amino group of any of B1 to B5 is blocked include a ketimine compound obtained from amine selected from any of (B 1) to (B5) and ketone (e.g., acetone, methyl ethyl ketone, and methyl isobutyl ketone), and an oxazoline compound.

Note that, in order to terminate an elongation reaction or crosslink reaction between the active hydrogen group-containing compound and the polymer reactable with the active hydrogen group-containing compound, a reaction terminator can be used. Use of the reaction terminator is preferable, as a molecular weight of the adhesive base can be controlled to the desirable range. Examples of the reaction terminator include monoamine (e.g., diethyl amine, dibutyl amine, butyl amine, and lauryl amine), and a blocked product thereof (e.g., a ketimine compound).

A blending ratio of the amine (B) and the isocyanate group-containing polyester prepolymer (A) is represented as a blending equivalent ratio ([NCO]/[NHx]) of isocyanate groups [NCO] in the isocyanate group-containing polyester prepolymer (A) to amino groups [NHx] in the amine. The blending equivalent ratio ([NCO]/[NHx]) is preferably 1/3 to 3/1, more preferably 1/2 to 2/1, and even more preferably 1/1.5 to 1.5/1.

When the blending equivalent ratio ([NCO]/[NHx]) is less than ⅓, low temperature fixing ability of a resulting toner may be insufficient. When the blending equivalent ratio is more than 3/1, a molecular weight of the urea-modified polyester resin increases, which may lead to insufficient hot offset resistance of a resulting toner.

—Polymer Reactable with Active Hydrogen Group-Containing Compound—

The polymer reactable with the active hydrogen group-containing compound (may be referred to as a “prepolymer” hereinafter) is appropriately selected from conventional resins without any limitation, provided that the polymer contains at least a segment reactable with the active hydrogen group-containing compound. Examples thereof include a polyol resin, a polyacryl resin, a polyester resin, an epoxy resin, and a derivative resin thereof.

These may be used alone, or in combination. Among them, the polyester resin is particularly preferable in view of its high fluidity as melted, and transparency.

The segment reactable with active hydrogen group-containing compound in the prepolymer is appropriately selected from conventional substituents without any limitation, and examples thereof include an isocyanate group, an epoxy group, carboxylic acid, and an acid chloride group.

These groups may be contained as alone, or in combination. Among them, the isocyanate group is particularly preferable.

Among the prepolymer, a urea bond generating group-containing polyester resin (RMPE) is particularly preferable, as it is easy to control a molecular weight of a high molecular component, and excellent releasing property and fixing ability can be provided to a resulting toner even when the toner is a dry toner used for oil-less low temperature fixing, especially when a release oil coating system is not provided for a heating member for fixing.

Examples of the urea bond generating group include an isocyanate group. In the case where the urea bond generating group in the urea bond generating group-containing polyester resin (RMPE) is an isocyanate group, the isocyanate group-containing polyester prepolymer (A) is particularly preferable as the polyester resin (RMPE).

The isocyanate group-containing polyester prepolymer (A) is appropriately selected depending on the intended purpose without any limitation, and examples thereof include a polycondensation product between polyol (PO) and polycarboxylic acid (PC), which is obtained through a reaction of the active hydrogen group-containing polyester resin with polyisocyanate (PIC).

Examples of the polyol (PO) is appropriately selected depending on the intended purpose without any limitation, and examples thereof include diol (DIO), trihydric or higher polyol (TO), and a mixture containing diol (DIO) and trihydric or higher polyol (TO). These may be used alone, or in combination. Among them, the diol (DIO) alone, and a mixture containing the diol (DIO) and a small amount of the trihydric or higher polyol (TO) are preferable.

Examples of the diol (DIO) include alkylene glycol, alkylene ether glycol, alicyclic diol, an alkylene oxide adduct of alicyclic diol, bisphenol, and an alkylene oxide adduct of bisphenol.

The alkylene glycol is preferably C2-C12 alkylene glycol, and examples thereof include ethylene glycol, 1,2-propylene glycol, 1,3-propylene glycol, 1,4-butanediol, and 1,6-hexanediol. Examples of the alkylene ether glycol include diethylene glycol, triethylene glycol, dipropylene glycol, polyethylene glycol, polypropylene glycol, and polytetramethylene ether glycol. Examples of the alicyclic diol include 1,4-cyclohexane dimethanol, and hydrogenated bisphenol A. Examples of the alkylene oxide adduct of alicyclic diol include compounds obtained by adding alkylene oxide (e.g., ethylene oxide, propylene oxide, and butylene oxide) to any of the above-listed alicyclic diols. Examples of the bisphenol include bisphenol A, bisphenol F, and bisphenol S. Examples of the alkylene oxide of bisphenol include compounds obtained by adding alkylene oxide (e.g., ethylene oxide, propylene oxide, and butylene oxide) to any of the above-listed bisphenols.

Among them, the C2-C12 alkylene glycol, and the alkylene oxide adduct of bisphenol are preferable, and the alkylene oxide adduct of bisphenol, and a mixture containing the alkylene oxide of bisphenol and the C2-C12 alkylene glycol are particularly preferable.

The trihydric or higher polyol (TO) is preferably trihydric to octahydric or higher polyol, and examples thereof include trihydric or higher polyhydric aliphatic alcohol, trihydric or higher polyphenol, and an alkylene oxide adduct of trihydric or higher polyphenol.

Examples of the trihydric or higher polyhydric aliphatic alcohol include glycerin, trimethylol ethane, trimethylol propane, pentaerythritol, and sorbitol.

Examples of the trihydric or higher polyphenol include trisphenol PA, phenol novolak, and cresol novolak. Examples of the alkylene oxide adduct of trihydric or higher polyphenol include compounds obtained by adding an alkylene oxide (e.g., ethylene oxide, propylene oxide, and butylene oxide) to any of the above-listed trihydric or higher polyphenols.

In the mixture containing the diol (DIO) and trihydric or higher polyol (TO), a blending mass ratio (DIO:TO) of the diol (DIO) to the trihydric or higher polyol (TO) is preferably 100:0.01 to 100:10, more preferably 100:0.01 to 100:1.

The polycarboxylic acid (PC) is appropriately selected depending on the intended purpose without any limitation, and examples thereof include dicarboxylic acid (DIC), trivalent or higher polycarboxylic acid (TC), and a mixture containing dicarboxylic acid (DIC) and trivalent or higher polycarboxylic acid (TC).

These may be used alone, or in combination. Among them, dicarboxylic acid (DIC) alone, and a mixture containing DIC and a small amount of trivalent or higher polycarboxylic acid (TC) are preferable.

Examples of the dicarboxylic acid include alkylene dicarboxylic acid, alkenylene dicarboxylic acid, and aromatic dicarboxylic acid.

Examples of the alkylene dicarboxylic acid include succinic acid, adipic acid, and sebacic acid. The alkenylene dicarboxylic acid is preferably C4-C20 alkenylene dicarboxylic acid, and examples thereof include maleic acid, and fumaric acid. The aromatic dicarboxylic acid is preferably C8-C20 aromatic decarboxylic acid, and examples thereof include phthalic acid, isophthalic acid, terephthalic acid, and naphthalene dicarboxylic acid.

Among them, C4-C20 alkenylene dicarboxylic acid, and C8-C20 aromatic dicarboxylic acid are preferable.

The trivalent or higher polycarboxylic acid (TO) is tri- to octavalent or higher polycarboxylic acid, and examples thereof include aromatic polycarboxylic acid.

The aromatic polycarboxylic acid is preferably C9-C20 aromatic polycarboxylic acid, and examples thereof include trimellitic acid, and pyromellitic acid.

As for the polycarboxylic acid (PC), acid anhydride or lower alkyl ester of one selected from the group consisting of the dicarboxylic acid (DIC), the trivalent or higher polycarboxylic acid (TC), and the mixture containing the dicarboxylic acid (DIC) and the trivalent or higher polycarboxylic acid (TC) can be used. Examples of the lower alkyl ester include methyl ester, ethyl ester, and isopropyl ester.

In the mixture containing the dicarboxylic acid (DIC) and the trivalent or higher polycarboxylic acid (TC), a blending mass ratio (DIC:TC) of the dicarboxylic acid (DIC) to the trivalent or higher polycarboxylic acid (TC) is appropriately selected depending on the intended purpose without any limitation. For example, the blending mass ratio thereof is preferably 100:0.01 to 100:10, more preferably 100:0.01 to 100:1.

A blending ratio when the polyol (PO) and the polycarboxylic acid (PC) are reacted through a polycondensation reaction is appropriately selected depending on the intended purpose without any limitation. For example, an equivalent ratio ([OH]/[COOH]) of hydroxyl groups [OH] in the polyol (PO) to carboxyl groups [COOH] in the polycarboxylic acid (PC) is, typically, preferably 2/1 to 1/1, more preferably 1.5/1 to 1/1, and even more preferably 1.3/1 to 1.02/1.

An amount of the polyol (PO) in the isocyanate group-containing polyester prepolymer (A) is appropriately selected depending on the intended purpose without any limitation, but it is, for example, preferably 0.5% by mass to 40% by mass, more preferably 1% by mass to 30% by mass, and even more preferably 2% by mass to 20% by mass.

When the amount of the polyol (PO) is less than 0.5% by mass, hot offset resistant of a resulting toner is insufficient, and thus it may be difficult to attain both heat resistant storage stability and low temperature fixing ability of the toner. When the amount thereof is greater than 40% by mass, low temperature fixing ability of a resulting toner may be insufficient.

The polyisocyanate (PIC) is appropriately selected depending on the intended purpose without any limitation, and examples thereof include aliphatic polyisocyanate, alicyclic polyisocyanate, aromatic diisocyanate, aromatic aliphatic diisocyanate, isocyanurate, a phenol derivative thereof, and a block product thereof with oxime or caprolactam.

Examples of the aliphatic polyisocyanate include tetramethylene diisocyanate, hexamethylene diisocyanate, 2,6-diisocyanatomethylcaproate, octamethylene diisocyanate, decamethylene diisocyanate, dodecamethylene diisocyanate, tetradecamethylene diisocyanate, trimethylhexane diisocyanate, and tetramethylhexane diisocyanate. Examples of the alicyclic polyisocyanate include isophorone diisocyanate, and cyclohexylmethane diisocyanate. Examples of the aromatic diisocyanate include tolylene diisocyanate, diphenylmethane diisocyanate, 1,5-naphthylene diisocyanate, diphenylene-4,4′-diisocyanate, 4,4′-diisocyanato-3,3′-dimethyldiphenyl, 3-methyldiphenylmethane-4,4′-diisocyanate, and diphenyl ether-4,4′-diisocyanate. Examples of the aromatic aliphatic diisocyanate include α,α,α′,α′-tetramethylxylene diisocyanate. Examples of the isocyanurate include tris-isocyanatoalkyl-isocyanurate, and triisocyanatocycloalkyl-isocyanurate.

These may be used alone, or in combination.

As for a blending ratio when the polyisocyanate (PIC) and the active hydrogen group-containing polyester resin (e.g., a hydrogen group-containing polyester resin) are allowed to react, a blending equivalent ratio ([NCO]/[OH]) of isocyanate groups [NCO] in the polyisocyanate (PIC) to hydroxyl groups [OH] in the hydroxyl group-containing polyester resin is, typically, preferably 5/1 to 1/1, more preferably 4/1 to 1.2/1, and even more preferably 3/1 to 1.5/1.

When the ratio of the isocyanate groups [NCO] is greater than 5, low temperature fixing ability of a resulting toner may be insufficient. When the ratio thereof is less than 1, offset resistance of a resulting toner may be insufficient.

An amount of the polyisocyanate (PIC) in the isocyanate group-containing polyester prepolymer (A) is appropriately selected depending on the intended purpose without any limitation. For example, the amount thereof is preferably 0.5% by mass to 40% by mass, more preferably 1% by mass to 30% by mass, and even more preferably 2% by mass to 20% by mass.

When the amount thereof is less than 0.5% by mass, hot offset resistance of a resulting toner is insufficient, and thus it may be difficult to attain both heat resistant storage stability and low temperature fixing ability of the toner. When the amount thereof is greater than 40% by mass, low temperature fixing ability of a resulting toner may be insufficient.

The average number of isocyanate groups contained per molecule of the isocyanate group-containing polyester prepolymer (A) is preferably 1 or greater, more preferably 1.2 to 5, and even more preferably 1.5 to 4.

When the average number of the isocyanate group is less than 1, a molecular weight of the urea bond generating group-containing polyester resin (RMPE) becomes small, which may lead to insufficient hot offset resistance of a resulting toner.

The weight average molecular weight (Mw) of the polymer reactive with the active hydrogen group-containing compound is preferably 3,000 to 40,000, more preferably 4,000 to 30,000, based on the molecular weight distribution as measured by gel permeation chromatography (GPC) of a tetrahydrofuran (THF) soluble component. When the weight average molecular weight (Mw) thereof is smaller than 3,000, the heat resistant storage stability of a resulting toner may be impaired. When Mw thereof is greater than 40,000, the low temperature fixing ability of a resulting toner may be impaired.

The measurement of the molecular weight distribution by gel permeation chromatography (GPC) can be performed, for example, in the following manner.

Specifically, at first, a column is stabilized in a heat chamber of 40° C. At this temperature, tetrahydrofuran (THF) as a column solvent is flown into the column at the flow rate of 1 mL/min, and 50 μL to 200 μL of a tetrahydrofuran resin sample solution whose sample concentration is adjusted to 0.05% by mass to 0.6% by mass is injected to carry out a measurement. As for the measurement of the molecular weight of the sample, the molecular weight distribution of the sample is calculated from the relationship with a logarithmic value and count number of a calibration curve formed by a plurality of monodisperse polystyrene standard samples.

As for standard polystyrene samples for forming a calibration curve, standard polystyrene samples (of Pressure Chemical Co., or Tosoh Corporation) having molecular weights of 6×10², 2.1×10³, 4×10³, 1.75×10⁴, 1.1×10⁵, 3.9×10⁵, 8.6×10⁵, 2×10⁶, and 4.48×10⁶ are used. It is preferred that at least 10 standard polystyrene samples be used. Note that, as for a detector, an RI (refractive index) detector can be used.

### —Binder Resin—

The binder resin is appropriately selected depending on the intended purpose without any limitation, and examples thereof include a polyester resin. An unmodified polyester resin (a polyester resin that has not been modified) is particularly preferable as the binder resin.

Use of the unmodified polyester resin in the toner can improve low temperature fixing ability and glossiness.

Examples of the unmodified polyester resin include the ones same as the urea bond generating group-containing polyester resin, specifically, a polycondensation product between polyol (PO) and polycarboxylic acid (PC). It is preferred that part of the unmodified polyester resin be compatible to the urea bond generating group-containing polyester-based resin (RMPE), i.e., the both having similar structures that can be compatible to each other, in view of low temperature fixing ability and hot offset resistance.

The weight average molecular weight (Mw) of the unmodified polyester resin is preferably 1,000 to 30,000, more preferably 1,500 to 15,000, based on the molecular weight distribution of the tetrahydrofuran (THF) soluble component, as measured by gel permeation chromatography (GPC).

When the weight average molecular weight (Mw) is smaller than 1,000, the heat resistant storage stability may be impaired. Accordingly, as described above, the amount of the component having the weight average molecular weight (Mw) of smaller than 1,000 is 8% by mass to 28% by mass. When the weight average molecular weight (Mw) is greater than 30,000, on the other hand, the low temperature fixing ability may be impaired.

The glass transition temperature of the unmodified polyester resin is preferably 35° C. to 70° C. When the glass transition temperature thereof is lower than 35° C., heat resistant storage stability of a resulting toner may be impaired. When the glass transition temperature thereof is higher than 70° C., a resulting toner may have insufficient low temperature fixing ability.

The hydroxyl value of the unmodified polyester resin is preferably 5 mgKOH/g or greater, more preferably 10 mgKOH/g to 120 mgKOH/g, and even more preferably 20 mgKOH/g to 80 mgKOH/g. When the hydroxyl value thereof is less than 5 mgKOH/g, it may be difficult to attain both heat resistant storage stability and low temperature fixing ability of a resulting toner.

The acid value of the unmodified polyester resin is typically 1.0 mgKOH/g to 30.0 mgKOH/g, preferably 5.0 mgKOH/g to 20.0 mgKOH/g. Typically, the toner tends to be negatively charged by giving the toner the acid value.

In the case where the unmodified polyester resin is contained in the toner, a blending mass ratio (RMPE/PE) of the urea bond generating group-containing polyester-based resin (RMPE) to the unmodified polyester resin (PE) is preferably 5/95 to 25/75, more preferably 10/90 to 25/75.

When the blending mass ratio of the unmodified polyester resin (PE) is greater than 95, hot offset resistant may be impaired. When the blending mass ratio thereof is less than 75, low temperature fixing ability or glossiness of a resulting image may be impaired.

An amount of the unmodified polyester resin in the binder resin is, for example, preferably 50% by mass to 100% by mass, more preferably 55% by mass to 95% by mass. When the amount thereof is less than 50% by mass, low temperature fixing ability, strength of a fixed image, or glossiness may be impaired.

The adhesive base (e.g., the urea-modified polyester resin) may be generated, for example, by (1) emulsifying or dispersing the oil phase containing the polymer reactive with the active hydrogen group-containing compound (e.g., the isocyanate group-containing polyester prepolymer (A)) in the aqueous phase together with the active hydrogen group-containing compound (e.g., the amine (B)) to form the oil droplets, and allowing the polymer and the active hydrogen group-containing compound to react through an elongation reaction or crosslink reaction in the aqueous medium, or by (2) emulsifying or dispersing the oil phase in the aqueous phase, to which the active hydrogen group-containing compound has been added in advance, and allowing the both to react through an elongation reaction or crosslink reaction in the aqueous medium, or by (3) adding the active hydrogen group-containing compound, after adding and mixing the oil phase into the aqueous phase, to thereby form the oil droplets, and allowing the both to react through an elongation reaction or crosslink reaction from interfaces of the particles in the aqueous phase. Note that, in the case of (3), the modified polyester resin is generated preferentially at a surface of a toner particle generated so that concentration gradient of the modified polyester resin can be provided in the toner particle.

The reaction conditions for generating the adhesive base by the emulsifying or dispersing are appropriately selected depending on a combination of the active hydrogen group-containing compound and the polymer reactable with the active hydrogen group-containing compound without any limitation. The reaction time is preferably 10 minutes to 40 hours, more preferably 2 hours to 24 hours. The reaction temperature is preferably 0° C. to 150° C., more preferably 40° C. to 98° C.

As for a method for stably forming the dispersed elements containing the polymer reactable with the active hydrogen group-containing compound in the aqueous phase, there is, for example, a method containing: adding the oil phase to the aqueous phase, where the oil phase is prepared by dissolving or dispersing, in the organic solvent, the toner materials, such as the polymer reactable with the active hydrogen group-containing compound (e.g., the isocyanate group-containing polyester prepolymer (A)), the colorant, the releasing agent, the charge controlling agent, and the unmodified polyester resin, and dispersing by shearing force.

An amount of the aqueous phase for use in the emulsifying or dispersing is preferably 50 parts by mass to 2,000 parts by mass, more preferably 100 parts by mass to 1,000 parts by mass, relative to 100 parts by mass of the toner materials.

When the amount thereof is less than 50 parts by mass, the dispersed state of the toner materials is not preferable, and therefore toner particles having the predetermined particle diameters may not be obtained. When the amount thereof is greater than 2,000 parts by mass, the production cost increases.

### —Crystalline Resin—

As for the toner particles of the present invention, a preferred embodiment is toner particles in each of which a crystalline resin is contained in the binder resin. The crystalline resin is appropriately selected depending on the intended purpose without any limitation, but among them, a crystalline polyester resin is preferable.

The crystalline polyester resin has crystallinity and heat melt characteristics that the viscosity thereof is rapidly dropped at the temperature around the fixing onset temperature. Specifically, the heat resistant storage stability of the toner is excellent due to the crystallinity just below the melt onset temperature, and the toner causes rapid viscosity decrease (sharp melt) at the melt onset temperature to be fixed. Accordingly, the toner achieving both excellent heat resistant storage stability and low temperature fixing ability can be produced. Moreover, the toner has the excellent release width (difference between the minimum fixing temperature and hot offset occurring temperature).

The crystalline polyester is appropriately selected depending on the intended purpose without any limitation, and for example, it is preferably a crystalline polyester resin synthesized using a C2-C6 diol component, particularly 1,4-butanediol, 1,6-hexanediol, or a derivative thereof, as an alcohol component in an amount of 80 mol % or greater, preferably 85 mol % to 100 mol %, and at least an acid component, such as maleic acid, fumaric acid, succinic acid, and a derivative thereof.

### —Colorant—

The colorant is appropriately selected from conventional dyes and pigments depending on the intended purpose without any limitation. Examples thereof include carbon black, nigrosine dye, iron black, Naphthol Yellow S, Hansa Yellow (10G, 5G, G), cadmium yellow, yellow iron oxide, yellow ocher, chrome yellow, Titan Yellow, Polyazo Yellow, Oil Yellow, Hansa Yellow (GR, A, RN, R), Pigment Yellow L, Benzidine Yellow (G, GR), Permanent Yellow (NCG), Vulcan Fast Yellow (5G, R), Tartrazine Lake, Quinoline Yellow Lake, anthracene yellow BGL, isoindolinone yellow, colcothar, red lead oxide, lead red, cadmium red, cadmium mercury red, antimony red, Permanent Red 4R, Para Red, Fiser Red, parachloroanilineorthonitroaniline red, Lithol Fast Scarlet G, Brilliant Fast Scarlet, Brilliant Carmine BS, Permanent Red (F2R, F4R, FRL, FRLL, F4RH), Fast Scarlet VD, Vulcan Fast Rubine B, Brilliant Scarlet G, Lithol Rubine GX, Permanent Red F5R, Brilliant Carmine 6B, Pigment Scarlet 3B, Bordeaux 5B, Toluidine Maroon, Permanent Bordeaux F2K, Helio bordeaux BL, bordeaux 10B, BON maroon light, BON maroon medium, eosin lake, rhodamine lake B, rhodamine lake Y, alizarin lake, thioindigo red B, thioindigo maroon, oil red, quinacridone red, pyrazolone red, polyazo red, chrome vermilion, benzidine orange, perinone orange, oil orange, cobalt blue, cerulean blue, alkali blue lake, peacock blue lake, victoria blue lake, metal-free phthalocyanine blue, phthalocyanine blue, fast sky blue, indanthrene blue (RS, BC), indigo, ultramarine blue, iron blue, anthraquinone blue, fast violet B, methylviolet lake, cobalt purple, manganese violet, dioxane violet, anthraquinone violet, chrome green, zinc green, chromium oxide, viridian green, emerald green, pigment green B, naphthol green B, green gold, acid green lake, malachite green lake, phthalocyanine green, anthraquinone green, titanium oxide, zinc flower, and lithopone.

These may be used alone, or in combination.

An amount of the colorant in the toner is appropriately selected depending on the intended purpose without any limitation, but the amount thereof is preferably 1% by mass to 15% by mass, more preferably 3% by mass to 10% by mass.

When the amount thereof is smaller than 1% by mass, the coloring ability of the toner may be insufficient. When the amount thereof is greater than 15% by mass, the pigment may cause dispersion failures in the toner, which may lead to low coloring ability, and undesirable electric property of the toner.

The colorant may be used as a master batch, in which the colorant forms a composite with a resin. The resin for the master batch is appropriately selected from conventional resins depending on the intended purpose without any limitation. Examples thereof include: a styrene polymer and substituted products thereof; a styrene-based copolymer; a polymethyl methacrylate resin; a polybutyl methacrylate resin; a polyvinyl chloride resin; a polyvinyl acetate resin; a polyethylene resin; a polypropylene resin; a polyester resin; an epoxy resin, an epoxy polyol resin; a polyurethane resin; a polyamide resin; a polyvinyl butyral resin; a polyacrylic acid resin; rosin; modified rosin; a terpene resin; an aliphatic hydrocarbon resin; an alicyclic hydrocarbon resin; an aromatic petroleum resin; chlorinated paraffin; and paraffin wax. These may be used alone, or in combination.

Examples of the styrene polymer and substituted product thereof include a polyester resin, a polystyrene resin, a poly(p-chloroanilinestyrene) resin, and a polyvinyl toluene resin. Examples of the styrene-based copolymer include a styrene-p-chloroanilinestyrene copolymer, a styrene-propylene copolymer, a styrene-vinyltoluene copolymer, a styrene-vinyl naphthalene copolymer, a styrene-methyl acrylate copolymer, a styrene-ethyl acrylate copolymer, a styrene-butyl acrylate copolymer, a styrene-octyl acrylate copolymer, a styrene-methyl methacrylate copolymer, a styrene-ethyl methacrylate copolymer, a styrene-butyl methacrylate copolymer, styrene-methyl-α-chloroanilinemethacrylate copolymer, a styrene-acrylonitrile copolymer, a styrene-vinyl methyl ketone copolymer, a styrene-butadiene copolymer, a styrene-isoprene copolymer, a styrene-acrylonitrile-indene copolymer, a styrene-maleic acid copolymer, and a styrene-maleic acid ester copolymer.

The master batch can be produced by mixing or kneading the resin for the master batch and the colorant together through application of high shearing force. Preferably, an organic solvent may be used for improving the interactions between the colorant and the resin. Further, a so-called flashing method is preferably used, since a wet cake of the colorant can be directly used, i.e., no drying is required. Here, the flashing method is a method in which an aqueous paste containing a colorant is mixed or kneaded with a resin and an organic solvent, and then the colorant is transferred to the resin to remove the water and the organic solvent. In this mixing or kneading, a high-shearing disperser (e.g., a three-roll mill) is preferably used.

### —Releasing Agent—

The releasing agent is appropriately selected from those known in art depending on the intended purpose without any limitation, and examples thereof include wax.

Examples of the wax include carbonyl group-containing wax, polyolefin wax, and long chain hydrocarbon. These may be used alone, or in combination. Among them carbonyl group-containing wax is preferable.

Examples of the carbonyl group-containing wax include polyalkanoic acid ester, polyalkanol ester, polyalkanoic acid amide, polyalkyl amide, and dialkyl ketone. Examples of the polyalkanoic acid ester include carnauba wax, montan wax, trimethylolpropane tribehenate, pentaerythritol tetrabehenate, pentaerythritol diacetate dibehenate, glycerin tribehenate, and 1,18-octadecanediol distearate. Examples of the polyalkanol ester include tristearyl trimellitate, and distearyl maleate. Examples of the polyalkanoic acid amide include dibehenyl amide. Examples of the polyalkyl amide include trimellitic acid tristearyl amide. Examples of the dialkyl ketone include distearyl ketone. Among the carbonyl group-containing wax mentioned above, polyalkanoic acid ester is particularly preferable.

Examples of the polyolefin wax include polyethylene wax, and polypropylene wax.

Examples of the long chain hydrocarbon include paraffin wax, and Sasol wax.

The melting point of the releasing agent is appropriately selected depending on the intended purpose without any limitation, but it is preferably 40° C. to 160° C., more preferably 50° C. to 120° C., and even more preferably 60° C. to 90° C.

When the melting point thereof is lower than 40° C., use of such releasing agent may adversely affect the heat resistant storage stability of the resulting toner. When the melting point thereof is higher than 160° C., a resulting toner tends to cause cold offset during the fixing at low temperature.

A melt viscosity of the releasing agent, which is measured at the temperature higher than the melting point of the releasing agent by 20° C., is preferably 5 cps to 1,000 cps, more preferably 10 cps to 100 cps.

When the melt viscosity thereof is lower than 5 cps, releasing ability of a toner may be degraded. When the melt viscosity thereof is higher than 1,000 cps, an effect of improving hot offset resistance and low temperature fixing ability may not be attained.

An amount of the releasing agent in the toner is appropriately selected depending on the intended purpose without any limitation, but it is preferably 0% by mass to 40% by mass, more preferably 3% by mass to 30% by mass. When the amount thereof is greater than 40% by mass, flowability of a resulting toner may be impaired.

### —Other Components—

The aforementioned other components are appropriately selected depending on the intended purpose without any limitation, and examples thereof include a charge controlling agent, inorganic particles, a flow improving agent, a cleaning improving agent, a magnetic material, and metal soap.

The charge controlling agent is appropriately selected from those known in the art depending on the intended purpose without any limitation, but it is preferably a material that is clear, and/or close to white in color, as use of a color material may change a color tone of a resulting toner. Examples of the charge controlling agent include a triphenyl methane-based dye, a molybdic acid chelate pigment, a rhodamine dye, alkoxy amine, quaternary ammonium salt (including fluorine-modified quaternary ammonium salt), alkyl amide, phosphorus or a phosphorus compound, tungsten or a tungsten compound, a fluorine-based active agent, a metal salt of salicylic acid, and a metal salt of a salicylic acid derivative. These may be used alone, or in combination.

The charge controlling agent may be selected from commercial products. Examples of the commercial product thereof include: quaternary ammonium salt BONTRON P-51, oxynaphthoic acid-based metal complex E-82, salicylic acid-based metal complex E-84 and phenol condensate E-89 (all manufactured by ORIENT CHEMICAL INDUSTRIES CO., LTD); quaternary ammonium salt molybdenum complex TP-302 and TP-415 (all manufactured by Hodogaya Chemical Co., Ltd.); quaternary ammonium salt COPY CHARGE PSY VP 2038, triphenylmethane derivative COPY BLUE PR, quaternary ammonium salt COPY CHARGE NEG VP2036 and COPY CHARGE NX VP434 (all manufactured by Clariant K.K.); LRA-901, and a boron complex LR-147 (both manufactured by Japan Carlit Co., Ltd.); quinacridon; an azo-based pigment; and a polymer compound having a functional group, such as a sulfonic acid group, a carboxyl group, and quaternary ammonium salt.

The charge controlling agent may be melt-kneaded with the master batch, and then be dissolved and/or dispersed, or may be added when it is dissolved and/or dispersed together with other components of the toner. Alternatively, the charge controlling agent may be fixed on surfaces of toner particles after the production of the toner particles.

An amount of the charge controlling agent in the toner varies depending on the binder resin for use, the presence or absence of additives, or a dispersing method, and therefore cannot be defined unconditionally. For example, the amount of the charge controlling agent is preferably 0.1 parts by mass to 10 parts by mass, more preferably 0.2 parts by mass to 5 parts by mass relative to 100 parts by mass of the binder resin. When the amount thereof is smaller than 0.1 parts by mass, the control of the charge by the charge controlling agent may not be achieved. When the amount thereof is greater than 10 parts by mass, the electrostatic propensity of the resulting toner is excessively large, and therefore an effect of the charge controlling agent is reduced and electrostatic force to a developing roller increases, which may reduce flowability of a developer, or reduce image density of images formed with the resulting toner.

The inorganic particles are suitably used as external additives for improving flowability, developing ability, and charging ability of the toner. The inorganic particles are preferably the same to the inorganic particles dispersible in the organic solvent.

The inorganic particles are appropriately selected from those known in the art depending on the intended purpose without any limitation, and examples thereof include silica, alumina, titanium oxide, barium titanate, magnesium titanate, calcium titanate, strontium titanate, zinc oxide, tin oxide, silica sand, clay, mica, wollastonite, diatomite, chromium oxide, cerium oxide, colcothar, antimony trioxide, magnesium oxide, zirconium oxide, barium sulfate, barium carbonate, calcium carbonate, silicon carbide, and silicon nitride. These may be used alone, or in combination.

Primary particle diameters of the inorganic particles are preferably 5 nm to 2 more preferably 5 nm to 500 nm. Moreover, the BET specific surface area of the inorganic particles is preferably 20 m²/g to 500 m²/g.

An amount of the inorganic particles in the toner is preferably 0.01% by mass to 5.0% by mass, more preferably 0.01% by mass to 5.0% by mass.

The flow improving agent is an agent capable of performing surface treatment of the toner to increase hydrophobicity, and preventing degradations of flow properties and charging properties of the toner even in a high humidity environment. Examples of the flow improving agent include a silane-coupling agent, a sililation agent, a silane-coupling agent containing a fluoroalkyl group, an organic titanate-based coupling agent, an aluminum-based coupling agent, silicone oil, and modified silicone oil.

The cleaning improving agent is added to the toner for the purpose of removing the developer remained on a latent electrostatic image bearing member or intermediate transfer member after transferring. Examples of the cleaning improving agent include: fatty acid metal salt such as zinc stearate, calcium stearate, and stearic acid; and polymer particles produced by soap-free emulsification polymerization, such as polymethyl methacrylate particles, and polystyrene particles. The polymer particles are preferably those having a relatively narrow particle size distribution, and the polymer particles having the volume average particle diameter of 0.01 μm to 1 μm are preferably used.

The magnetic material is appropriately selected from those known in the art depending on the intended purpose without any limitation, and examples thereof include iron powder, magnetite, and ferrite. Among them, a white magnetic material is preferable in view of color tone.

In the method for producing a toner of the preferred embodiment of the present invention, the preparation of the oil phase is performed by dissolving or dispersing, in the organic solvent, toner materials, such as the active hydrogen group-containing compound, the polymer reactable with the active hydrogen group-containing compound, the colorant, the releasing agent, and the charge controlling agent.

Note that, among the toner materials, the components, other than the polymer (prepolymer) reactable with the active hydrogen group-containing compound may be added to and mixed in the aqueous phase when the resin particles are dispersed in the aqueous phase in the preparation of the aqueous phase, or added to the aqueous phase together with the oil phase, when the oil phase is added to the aqueous phase.

### —Convergence—

The convergence is carried out by combining oil droplets present adjacent to each other, where the oil droplets are formed by emulsifying or dispersing the oil phase in the aqueous phase. As a result of the convergence, one particle is formed from the oil droplets present adjacent to each other.

The convergence is performed when a toner is produced in a toner production method where a toner is granulated in an aqueous phase, such as a conventional suspension polymerization method, emulsified polymerization method, dissolution suspension method, and the below-described toner production method where an adhesive base is generated into particles.

When emulsification or dispersion is performed by applying high shearing force for emulsifying or dispersing the oil phase in the aqueous phase, not only in the case where the oil phase exhibits Newtonian viscosity, but also on the case where the oil phase exhibits non-Newtonian viscosity, the structural viscosity is destroyed by the high shearing force to exhibit the viscosity close to a Newtonian fluid, and as a result, spherical oil droplets are formed according to the interfacial tension between the oil phase and the aqueous phase.

Then, low shearing force, such as slow stirring, is applied to the obtained oil droplets, or the convergence is performed in the still state, to thereby obtain a toner having a narrow particle size distribution. This is because, even in the case where the oil droplets have a wide particle size distribution, fine particles are reduced by combining small oil droplets with large oil droplets, to thereby narrow the particle size distribution as a whole.

In order to attain a toner containing toner particles of irregular shapes, it is necessary not to cause a flow inside the oil droplets during the convergence.

In the convergence, the oil droplets are released from high shearing force. In the case where the oil droplets exhibit non-Newtonian viscosity and has structural viscosity, therefore, the structural viscosity is recovered to combine the oil droplets together, or the oil droplets are combined while recovering the structural viscosity. The combined oil droplets have the structural viscosity, and therefore each droplet in the formed particle maintains its shape without causing a flow inside the oil droplet, to thereby form a particle having an irregular shape. For example, an oil droplet having a large particle diameter maintains its shape, i.e. the oil droplet of a large particle diameter, within the formed particle after the convergence. Moreover, an oil droplet having a small particle diameter maintains its shape, i.e. the oil droplet of a small particle diameter, while combined with the oil droplet of a large particle diameter.

Accordingly, whether the oil droplet has a large particle diameter or small particle diameter, the oil droplets are combined at interface thereof, but a shape of each oil droplet is relatively maintained, to thereby form a toner particle of an irregular shape.

### —Removal of Organic Solvent—

The removal of the organic solvent is removing the organic solvent from oil droplets formed by emulsifying or dispersing an oil phase containing the organic solvent in the aqueous phase.

The removal of the organic solvent is performed when a toner is produced by the toner production method of the preferable embodiment of the present invention.

In order to obtain a toner containing toner particles of irregular shapes, it is necessary not to cause a flow inside the oil droplets during the removal of the organic solvent.

In the case where the oil droplets has the non-Newtonian viscosity and structural viscosity, the viscosity of the oil droplets recovers with time, even when the structural viscosity thereof is destroyed by the emulsifying or dispersing. In the case where the structural viscosity thereof is not recovered at the time of convergence to form large spherical or substantially circular oil droplets, for example, the structural viscosity thereof is recovered with time and the organic solvent is removed. As a result, particles of irregular shapes are formed, as a flow is not caused within the oil droplet during the removal of the organic solvent, and the contraction of the surface area thereof cannot keep up with the uniform volume contraction.

In the removal of the organic solvent, a toner containing toner particles of irregular shapes can be formed, provided that the oil droplets exhibit non-Newtonian viscosity during the removal. The removal of the organic solvent preferably contains making the oil droplet convergence, and removing the organic solvent from the oil droplets after the convergence, in which the oil droplets during the convergence exhibit non-Newtonian viscosity, and the oil droplets during the removal of the organic solvent exhibits non-Newtonian viscosity. A toner containing toner particles of small diameters and irregular shapes can be attained, if the oil droplets during the convergence and during the removal of the organic solvent exhibit non-Newtonian viscosity.

As for the removal of the organic solvent, there are (1) a method containing gradually heating the entire reaction system to completely evaporate the organic solvent in the oil droplets, and (2) a method containing spraying the emulsified dispersion liquid in a dry atmosphere to completely remove the non-aqueous organic solvent in the oil droplet to form toner particles, as well as evaporating and removing an aqueous dispersant therein.

When the organic solvent is removed, toner particles are formed. Washing, drying, etc. can be performed on the toner particles, and thereafter, classification can be optionally performed on the toner particles. The classification can be performed by removing a fine particle component by a cyclone, a decanter, or centrifugal separation in the liquid. The classification may be performed on the powder obtained after drying. The washing is preferably alkali washing.

The above alkali washing can remove impurities other than the constituent components of the toner during the production of the toner, and can mainly remove, for example, inorganic salts and a surfactant effectively which are aqueous phase components.

The toner particles obtained in this manner are mixed together with particles, such as the colorant, releasing agent, and charge controlling agent. Alternatively, mechanical impacts are applied to the toner particles, to thereby prevent the particles, such as the releasing agent, from falling out from the surfaces of the toner particles.

Examples of the method for applying mechanical impacts include a method in which an impact is applied to a mixture using a high-speed rotating blade, and a method in which an impact is applied by putting mixed particles into a high-speed air flow and accelerating the air speed such that the particles collide against one another or that the particles are crashed into an appropriate collision plate. Examples of apparatuses used in these methods include ANGMILL (manufactured by Hosokawa Micron Corporation), an apparatus produced by modifying I-type mill (manufactured by Nippon Pneumatic Mfg. Co., Ltd.) so that the pulverizing air pressure thereof is decreased, a hybridization system (manufactured by Nara Machinery Co., Ltd.), a kryptron system (manufactured by Kawasaki Heavy Industries, Ltd.) and an automatic mortar.

The toner obtained by the method for producing a toner of the present invention preferably has the following average circularity, volume average particle diameter (Dv), volume average particle diameter (Dv)/number average particle diameter (Dn), penetration degree, low temperature fixing ability, offset non-occurring temperature, thermal characteristics, glass transition temperature, acid value, and image density.

The volume average particle diameter (Dv) of the toner is, for example, preferably 3 μm to 8 μm, more preferably 4 μm to 7 μm.

When the volume average particle diameter thereof is smaller than 3 μm, in case of a two-component developer, he toner is fused on the surfaces of carrier particles after being stirred for a long period in a developing device, which may lead to low charging ability of the carrier, or poor cleaning ability. In case of a one-component developer, toner filming to a developing roller, or a toner fusion to a member, such as a blade for reducing a thickness of a toner layer, tends to occur. When the volume average particle diameter is greater than 8 μm, it is difficult to form an image having high resolution and high image quality, and particle diameters of the toner particles may significantly change after the toner is supplied to the developer to compensate the spent toner.

The ratio (Dv/Dn) of the volume average particle diameter (Dv) to the number average particle diameter (Dn) of the toner is, for example, preferably 1.05 to 1.25, more preferably 1.05 to 1.20.

When the ratio (Dv/Dn) of the volume average particle diameter to the number average particle diameter is less than 1.05, in case of a two-component developer, the toner is fused on the surfaces of carrier particles after being stirred for a long period in a developing device, which may lead to low charging ability of the carrier, or poor cleaning ability. In case of a one-component developer, toner filming to a developing roller, or a toner fusion to a member, such as a blade for reducing a thickness of a toner layer, tends to occur. When the ratio (Dv/Dn) is greater than 1.25, it is difficult to form an image having high resolution and high image quality, and particle diameters of the toner particles may significantly change after the toner is supplied to the developer to compensate the spent toner.

When the ratio (Dv/Dn) of the volume average particle diameter to the number average particle diameter is 1.05 to 1.20, excellent heat resistant storage stability, low temperature fixing ability and hot offset resistance are all achieved, especially, a resulting toner gives excellent glossiness to an image, when the toner is used for a full-color photocopier. In the case of a two-component developer, diameters of the toner particles in the two-component developer do not change largely even when the toner is supplied to the developer to compensate the spent toner, and the toner can achieve excellent and stable developing ability even when the toner is stirred in a developing device for a long period. In the case of a one-component developer, diameters of the toner particles do not change largely even when the toner is supplied to the developer to compensate the spent toner, the toner does not cause filming to a developing roller, nor fuse to a layer thickness regulating member such as a blade for thinning a thickness of a layer of the toner, and provides excellent and stable developing ability and image even when it is stirred in the developing unit over a long period of time, and therefore it is possible to provide a high quality image.

The volume average particle diameter, and the ratio (Dv/Dn) of the volume average particle diameter to the number average particle diameter can be measured, for example, by means of a particle size analyzer (Multisizer III, manufactured by Bechman Coulter, Inc.).

The average circularity is the value obtained by dividing the boundary length of a circle having the same area to that of a projected area of the shape of the toner with the boundary length of an actual particle. For example, the average circularity is preferably 0.900 to 0.980, more preferably 0.900 to 0.970. Note that, it is preferred that the toner contain 10% or less of particles having the average circularity of 0.970 or greater.

When the average circularity is greater than 0.980, cleaning failures occur on the photoconductor or transfer belt in the image forming system employing a blade cleaning, smearing on an image occurs, for example, in the case where an image having a high imaging area ratio, such as a photographic image, is formed, the toner that forms a non-transferred image due to a paper feeding failure remains on the photoconductor was a transfer residual toner, and the accumulated image may cause background deposition, or deposit a charging roller configured to directly charge the photoconductor. Accordingly, the original charging capacity may not be exhibited. As for the average circularity with which excellent transfer ability, image quality, and cleaning ability are attained, the average circularity is preferably 0.940 to 0.970.

The average circularity can be measured, for example, by a optical detecting band method containing passing a suspension liquid containing the toner through an imaging detecting band on a plate to optically detect particle images by a CCD camera, and analyzing the particle images. The average circularity can be measured, for example, by means of a flow particle image analyzer (FPIA-2100, manufactured by Sysmex Corporation) in the following manner.

First, a container is charged with 100 mL to 150 mL of water, from which impurity solids have been removed in advance, followed by adding as a dispersant, a surfactant, preferably 0.1 mL to 0.5 mL of alkylbenzene sulfonate, and further adding about 0.1 g to about 0.5 g of a measuring sample. Subsequently, the resulting suspension liquid, in which the sample is dispersed, is dispersed for about 1 minute to about 3 minutes by means of a ultrasonic wave disperser, and the resulting dispersion liquid having a concentration of 3,000 particles/μL to 10,000 particles/μL is subjected to measurement of shape and distribution of the toner by means of the flow particle image analyzer.

As for the penetration degree, for example, the penetration degree measured by a penetration degree test (JIS K2235-1991) is 15 mm or greater, more preferably 20 mm to 30 mm. When the penetration degree is less than 15 mm, the heat resistance storage stability may be impaired. The penetration degree can be measured in accordance with, JIS K2235-1991. Specifically, a 50 mL glass container is filled with the toner, and the container is left to stand in a thermostat of 50° C. for 20 hours. The toner is then cooled to room temperature, and is subjected to the penetration test to thereby measure the penetration degree. Note that, the greater value of the penetration degree means more excellent heat resistant storage stability.

As for the low temperature fixing ability, the lower minimum fixing temperature is preferable, and the higher offset non-occurring temperature is preferable for the purpose of reducing the fixing temperature and preventing offset. As for temperature range in which the reduction in the fixing temperature and prevention in offset are both achieved, the minimum fixing temperature is lower than 140° C., and the offset non-occurring temperature 200° C. or higher. Note that, the minimum fixing temperature can be determined, for example, in the following manner. An image forming apparatus is used, transfer paper is set, and then a printing test is performed. The temperature of the fixing member at which the residual rate of the image density of the obtained fixed image after being scraped with a pad is 70% or greater is determined as the minimum fixing temperature. The offset non-occurring temperature can be determined, for example, in the following manner. An image forming apparatus is used, and is adjusted so that developing is performed with a certain amount of the toner to be evaluated, and the temperature of the fixing member is varied. Then, temperature at which offset does not occur is measured.

The thermal characteristics are also referred to as flow tester characteristics, and for example, the thermal characteristics are evaluated as softening temperature (Ts), flow onset temperature (Tfb), and ½-softening point (T½).

These thermal characteristic can be measured by an appropriately selected method, and for example, can be determined from a flow curve measured by means of a capillary rheometer CFT500 (manufactured by Shimadzu Corporation).

The softening temperature (Ts) is appropriately selected depending on the intended purpose without any limitation, and for example, it is preferably 30° C. or higher, more preferably 50° C. to 90° C. When the softening temperature (Ts) is lower than 30° C., heat resistant storage stability of the toner may be impaired.

The flow onset temperature (Tfb) is appropriately selected depending on the intended purpose without any limitation, and for example, it is preferably 60° C. or higher, more preferably 80° C. to 120° C. When the flow onset temperature (Tfb) is lower than 60° C., at least either of the heat resistant storage stability or offset resistance may be impaired.

The ½-softening point (T½) is appropriately selected depending on the intended purpose without any limitation, and for example, it is preferably 90° C. or higher, more preferably 100° C. to 170° C. When the ½-softening point (T½) is lower than 90° C., offset resistance may be impaired.

The glass transition temperature is appropriately selected depending on the intended purpose without any limitation, and for example, it is preferably 40° C. to 70° C., more preferably 45° C. to 65° C. When the glass transition temperature (Tg) is lower than 40° C., the heat resistant storage stability of the toner may be impaired. When the glass transition temperature (Tg) is higher than 70° C., the toner may have insufficient low temperature fixing ability.

The glass transition temperature can be measured, for example, by a differential scanning calorimeter (e.g., DSC-60, manufactured by Shimadzu Corporation). The acid value of the toner is, for example, preferably 0.5 KOHmg/g to 40.0 KOHmg/g, more preferably 3.0 KOHmg/g to 35.0 KOHmg/g. The toner tends to be negatively charged by giving the toner the acid value.

As for the image density, the density value measured by a spectrometer (938 spectrodensitometer, manufactured by X-Rite) is, for example, preferably 1.40 or greater, more preferably 1.45 or greater, and even more preferably 1.50 or greater.

When the image density is less than 1.40, the image density is low, and therefore a high quality image may not be attained.

The image density can be measured in the following manner. For example, using a tandem color electrophotographic device (imagio Neo 450, manufactured by Ricoh Company Limited), a solid image having the developer deposition amount of 1.00 mg/cm²±0.1 mg/cm² is formed on a printing sheet (Type 6200, manufactured by Ricoh Company Limited) with the fixing roller surface temperature of 160° C.±2° C. The image density of the obtained solid image was measured at randomly selected 5 spots by means of a spectrometer (938 spectrodensitometer, manufactured by X-Rite), and an average value thereof is calculated.

The BET specific surface area of the toner is, for example, preferably 0.5 m²/g to 8.0 m²/g, more preferably 0.5 m²/g to 7.5 m²/g. When the BET specific surface area is less than 0.5 m²/g, the organic particles remained on the toner surface form a film or densely cover the toner surface, and therefore the resin particles inhibit the adhesion between the binder resin component inside the toner and the fixing paper, which may increase the minimum fixing temperature. When the BET specific surface area is greater than 8.0 m²/g, the resin particles inhibit bleeding of the wax, and therefore a releasing effect of the wax is not exhibited, which may cause offset.

The specific surface area of the toner can be measured in accordance with the BET method. For example, a nitrogen has is adsorbed on a surface of a sample by means of a specific surface area measuring device TriStar 3000 (manufactured by Shimadzu Corporation), and the BET specific surface area of the sample can be measured in accordance with the BET multipoint method.

The acid value of the toner is, for example, preferably 0.5 KOHmg/g to 40.0 KOHmg/g, more preferably 3.0 KOHmg/g to 35.0 KOHmg/g, and even more preferably 5.0 KOHmg/g to 30.0 KOHmg/g. The toner tends to be negatively charged by giving the toner the acid value.

The color of the toner of the present invention is appropriately selected depending on the intended purpose without any limitation, and can be at least one selected from the group consisting of a black toner, cyan toner, a magenta toner, and a yellow toner. The toner of each color can be obtained by appropriately selecting a type of the colorant for use.

The method for producing a toner of the present invention produces a toner for developing a latent electrostatic image, which is obtained by the production method containing mixing a mixture containing at least a binder resin, a colorant, a releasing agent, and an organic solvent with an aqueous medium in the presence of resin particles to emulsify, to thereby form resin particles in each of which at least the colorant and the releasing agent are encapsulated in the binder resin. In the aqueous medium, at least an inorganic salt is added together with a surfactant, and the resin particles are effectively deposited the toner base particles, and therefore the produced toner has excellent heat resistance and durability.

Accordingly, the toner of the present invention can be suitably used in various fields, more preferably used in electrophotographic image formation, and particularly preferably used in the toner container housing the toner of the present invention, developer, process cartridge, image forming apparatus, and image forming method described below.

### (Developer)

The toner of the present invention can be used as a developer, and the developer may further contain appropriately selected other components, such as a carrier, if necessary. The developer may be a one-component developer or two-component developer. In the case where the developer is used for a high-sped printer corresponded to the recent improved information processing speed, the two-component developer is preferable in view of a long service life.

In the case of the one-component developer, excellent and stable developing performances and image can be achieved without largely varying particle diameters of the toner particles, without causing filming of the toner to a developing roller, or fusion of the toner to a member, such as a blade for thinning a thickness of a layer of the toner, even when the developer is used (stirred) in the developing device over a long period. In the case of the two-component developer using the toner of the present invention, the diameters of the toner particles in the developer do not vary largely even when the toner is balanced, and the toner can provide excellent and stabile developing performances even when the toner is stirred in the developing device over a long period of time. excellent and stable developing performances can be achieved.

The carrier is appropriately selected depending on the intended purpose without any limitation, but it preferably contains a core and a resin layer.

A material of the core is appropriately selected from conventional materials without any limitation. For example, it is preferably 50 emu/g to 90 emu/g manganese-strontium (Mn—Sr) material, or manganese-magnesium (Mn—Mg) material, and preferably a hard magnetic material such as iron powder (100 emu/g or higher), and magnetite (75 emu/g to 120 emu/g) for securing sufficient image density. Moreover, the material is preferably a soft magnetic material such as a copper-zinc (Cu—Zn) (30 emu/g to 80 emu/g) material because the toner particles born in the form of brush reduces an impact by contact to a latent electrostatic image bearing member, which is advantageous for providing high image quality. These may be used alone, or in combination.

As for particle diameter of the core, the volume average particle diameter thereof is preferably 10 μm to 150 μm, more preferably 40 μm to 100 μm.

When the average particle diameter (volume average particle diameter (D50)) thereof is smaller than 10 μm, the proportion of fine particles in the distribution of carrier particle diameters increases, causing carrier scattering because of low magnetization per carrier particle. When the average particle diameter thereof is greater than 150 μm, the specific surface area reduces, which may cause toner scattering, causing reproducibility especially in a solid image portion in a full color printing containing many solid image portions.

A material of the resin layer is appropriately selected from conventional resins depending on the intended purpose without any limitation, and examples thereof include an amino resin, a polyvinyl resin, a polystyrene resin, a halogenated olefin resin, a polyester resin, a polycarbonate resin, a polyethylene resin, a polyvinyl fluoride resin, a polyvinylidene fluoride resin, a polytrifluoroethylene resin, a polyhexafluoropropylene resin, copolymer of vinylidene fluoride and acryl monomer, vinylidene fluoride-vinyl fluoride copolymer, fluoroterpolymer (e.g., terpolymer of tetrafluoroethylene, vinylidene fluoride, and non-fluoromonomer), and a silicone resin. These may be used alone, or in combination.

Examples of the amino resin include a urea-formaldehyde resin, a melamine resin, a benzoguanamine resin, a urea resin, a polyamide resin, and an epoxy resin. Examples of the vinyl resin include an acryl resin, a polymethyl methacrylate resin, a polyacrylonitrile resin, a polyvinyl acetate resin, a polyvinyl alcohol resin, and a polyvinyl butyral resin. Examples of the polystyrene resin include a polystyrene resin, a styrene-acryl copolymer resin. Examples of the halogenated olefin resin include polyvinyl chloride. Examples of the polyester resin include a polyethylene terephthalate resin, and a polybutylene terephthalate resin.

The resin layer optionally contains electric conductive powder, and examples thereof include metal powder, carbon black, titanium oxide, tin oxide, and zinc oxide. The average particle diameter of the electric conductive powder is preferably 1 μm or smaller. When the average particle diameter thereof is greater than 1 μm, it may be difficult to control electric resistance.

The resin layer can be formed, for example, by dissolving the silicone resin in a solvent to prepare a coating solution, uniformly applying the costing solution to surfaces of the core (particles) by a conventional coating method, and drying the coating solution, followed by baking. Examples of the coating method include dip coating, spray coating, and brush coating.

The solvent is appropriately selected depending on the intended purpose without any limitation, and examples thereof include toluene, xylene, methyl ethyl ketone, methyl isobutyl ketone, cellosolve, and butyl acetate.

A method for the baking is appropriately selected depending on the intended purpose without any limitation, and for example, the baking may employ an external heating system or an internal heating system. Examples thereof include a method using a fix electric furnace, a flow electric furnace, a rotary electric furnace, or a burner furnace, and a method using microwaves.

An amount of the resin layer in the carrier is preferably 0.01% by mass to 5.0% by mass.

When the amount thereof is smaller than 0.01% by mass, a uniform resin layer may not be formed on a surface of a core. When the amount thereof is greater than 5.0% by mass, a thickness of the resin layer becomes excessively thick so that a plurality of carrier particles may form into one particle, and therefore uniform carrier particles cannot be obtained.

In the case where the developer is a two-component developer, an amount of the carrier in the two-component developer is appropriately selected depending on the intended purpose without any limitation, but it is preferably 90% by mass to 98% by mass, more preferably 93% by mass to 97% by mass.

The developer using the toner of the present invention has excellent cleaning ability, and can stably form a high quality image. The developer using the toner of the present invention can be suitably used in image formation performed by various conventional electrophotographic methods, such as a magnetic one-component developing method, a non-magnetic one component developing method, and a two-component developing method. The developer is particularly preferably used for a toner container, process cartridge, image forming apparatus, and image forming method of the present invention described hereinafter.

### (Toner Container)

The toner of the present invention is loaded in a container, and the container is detachably mounted in an image forming apparatus.

The container is appropriately selected from conventional containers depending on the intended purpose without any limitation, and examples thereof include a toner container composed of a toner container main body and a cap.

A size, shape, structure, and material of the toner container main body are appropriately selected depending on the intended purpose without any limitation. For example, the shape thereof is preferably a cylinder, and particularly preferably a shape where recess (a convexoconcave shape) is spirally formed in the internal circumference surface to thereby enable the content, that is the toner, to move to the side of the discharging outlet by rotation of the container main body, and the part of or entire spiral recess section functions as bellows.

The material of the toner container main body is not particularly limited, but it is preferably selected from materials that are excellent in dimensional accuracy on the production. Preferable examples thereof include resins. Among them, for example, a polyester resin, a polyethylene resin, a polypropylene resin, a polystyrene resin, a polyvinyl chloride resin, polyacrylic acid, a polycarbonate resin, an ABS resin, a polyacetal resin are preferable.

The toner container is easy to store and transport, excellent in handling, and can be suitably used in the process cartridge mentioned later to supply a developer by detachably mounting the toner container therein.

### (Process Cartridge)

The toner of the present invention is suitably used in a process cartridge.

The process cartridge contains at least a latent electrostatic image bearing member configured to beat a latent electrostatic image, and a developing unit configured to develop the latent electrostatic image borne on the latent electrostatic image bearing member with a developer to form a visible image, and may further contain appropriately selected other units, if necessary.

The developing unit contains at least a developer container housing the toner of the present invention or the developer, and a developer bearing member configured to bear the toner or developer housed in the developer container and to transport the toner or developer, and may further contain a layer thickness regulating member configured to regulate a thickness of the toner layer to be borne. The process cartridge can be detachably mounted in various electrophotographic devices, and is preferably detachably mounted in the electrophotographic device of the present invention, which will be described below.

### (Image Forming Method and Image Forming Apparatus)

The toner of the present invention can be suitably used for an image forming apparatus and an image forming method.

The image forming method contains at least a latent electrostatic image forming step, a developing step, a transferring step, and a fixing step, and may further contain appropriately selected other steps, such as a diselectrification step, a cleaning step, a recycling step, and a controlling step, if necessary.

The image forming apparatus contains at least a latent electrostatic image bearing member, a latent electrostatic image forming unit, a developing unit, a transferring unit, and a fixing unit, and may further contain appropriately selected other units, such as a diselectrification unit, a cleaning unit, a recycling unit, and a controlling unit, if necessary.

### —Latent Electrostatic Image Forming Step and Latent Electrostatic Image Forming Unit—

The latent electrostatic image forming step is forming a latent electrostatic image on the latent electrostatic image bearing member.

A material, shape, structure, and size of the latent electrostatic image bearing member (may be referred to as a “photoconductive insulator” or “photoconductor” hereinafter). Examples of the material thereof include: an inorganic photoconductor, such as amorphous silicon, and selenium; and an organic photoconductor, such as polysilane, and phthalopolymethine. Among them, the amorphous silicon is preferable in view of long service life.

The formation of the latent electrostatic image can be performed, for example, by after uniformly charging a surface of the latent electrostatic image bearing member, exposing the surface thereof to light imagewise, and can be performed by means of the latent electrostatic image forming unit.

The latent electrostatic image forming unit contains, for example, at least a charging unit configured to uniformly charge a surface of the latent electrostatic image bearing member, and an exposing unit configured to expose the surface of the latent electrostatic image bearing member to light image wise.

The charging can be performed, for example, by applying voltage to a surface of the latent electrostatic image bearing member by means of the charging unit.

The charging unit is appropriately selected depending on the intended purpose without any limitation, and examples thereof include: conventional contact charging units equipped with an electric conductive or semiconductive roller, brush, film or rubber blade; and non-contact chargers utilizing corona discharge such as corotron, and scorotron.

The exposing can be performed, for example, by exposing a surface of the latent electrostatic image bearing member to light imagewise by means of the exposing unit.

The exposing unit is appropriately selected depending on the intended purpose without any restriction, provided that it can expose the charged surface of the latent electrostatic image bearing member by the charging unit to light imagewise corresponding to an image to be formed. Examples thereof include various exposing devices, such as a reproduction optical exposing device, a rod-lens array exposing device, a laser optical exposure device, and a liquid crystal shutter optical device.

Note that, in the present invention, a back light system where the imagewise exposing is performed from the back side of the latent electrostatic image bearing member may be employed.

### —Developing Step and Developing Unit—

The developing step is developing the latent electrostatic image with the toner of the present invention or the developer to form a visible image.

The formation of the visible image can be performed, for example, by developing the latent electrostatic image with the toner of the present invention or the developer, and can be performed by the developing unit.

The developing unit is appropriately selected from conventional developing units without any limitation, provided that developing can be performed with the toner of the present invention or the developer. For example, preferred is a developing unit having at least a developing device housing the toner of the present invention or developer therein, and capable of applying the toner or developer to the latent electrostatic image in a contact or non-contact manner. More preferred is a developing device equipped with the toner container.

The developing device may be employ a dry developing system, or wet developing system, and may be a developing device for a singly color, or a developing device for a multi-color. Preferable examples of the developing device include a device having a stirrer configured to charge the toner or developer by frictions from stirring, and a rotatable magnetic roller.

In the developing device, for example, the toner and the carrier are mixed and stirred, and the toner is charged by the friction from the stirring. The charged toner is held on the surface of the rotatable magnetic roller in the form of a brush to form a magnetic brush. The magnetic roller is provided adjacent to the latent electrostatic image bearing member, part of the toner forming the magnetic brush on the surface of the magnetic roller is moved to the surface of the latent electrostatic image bearing member (photoconductor) by electrical attraction force. As a result, the latent electrostatic image is developed with the toner to form a visible image on the surface of the latent electrostatic image bearing member (photoconductor).

The developer housed in the developing device is the developer containing the toner of the present invention, and the developer may be a one-component developer, or two-component.

### —Transferring Step and Transferring Unit—

The transferring step is transferring the visible image onto a recording medium, but the preferable embodiment thereof is primary transferring the visible image onto an intermediate transfer member, followed by secondary transferring the visible image onto the recording medium, and the more preferable embodiment thereof uses two or more colors of the toner, more preferably a full-color toner, and contains a first transferring step, which contains transferring the visible images onto an intermediate transfer member to form a composite transfer image, and a secondary transferring step, which contains transferring the composite transfer image onto the recording medium.

The transferring can be performed, for example, by charging the latent electrostatic image bearing member (photoconductor), on which the visible image has been formed, by means of a transfer charging device, and this can be performed by the transferring unit. The preferable embodiment of the transferring unit contains a first transferring unit configured to transfer the visible images onto the intermediate transfer member to form a composite transfer image, and a secondary transferring unit configured to transfer the composite transfer image onto the recording medium.

Note that, the intermediate transfer member is appropriately selected from conventional transfer members depending on the intended purpose without any limitation, and preferable examples thereof include a transfer belt.

The transferring unit (the primary transferring unit, the secondary transferring unit) preferably contains at least a transfer device configured to charge the visible image formed on the latent electrostatic image bearing member (photoconductor) to release the visible image from the photoconductor to the side of the recording medium. The number of the transferring units mounted may be 1, or 2 or more.

Examples of the transfer device include a corona transfer device utilizing corona discharge, a transfer belt, a transfer roller, a pressure transfer roller, and an adhesion transfer member.

Note that, the recording medium is appropriately selected from conventional recording media (recording paper) without any limitation.

### —Fixing Step and Fixing Unit—

The fixing step is fixing the transferred visible image on the recording medium using the fixing unit. In this step, fixing may be performed every time when an image formed of the toner of each color is transferred onto the recording medium. Alternatively, fixing may be performed after the toners of all the colors are transferred to the recording medium in a laminated state.

The fixing unit is appropriately selected depending on the intended purpose without any limitation, but it is preferably a conventional heat press member. Examples of the heat press member include a combination of a heat roller and a press roller, and a combination of a heat roller, a press roller, and an endless belt.

The heating by the heat press member is typically, preferably 80° C. to 200° C.

Note that, in the present invention, for example, a conventional optical fixing device may be used together with or instead of the fixing step and the fixing unit, depending on the purpose.

The diselectrification step is applying diselectrification bias to the latent electrostatic image bearing member to diselectrify the latent electrostatic image bearing member, and the diselectrification step can be suitably carried out by a diselectrification unit.

The diselectrification unit is appropriately selected from conventional diselectrification units known in the art without any limitation, provided that it is capable of applying diselectrification bias to the latent electrostatic image bearing member. As for the diselectrification unit, for example, a diselectrification lamp is preferable.

The cleaning step is removing the residual toner on the latent electrostatic image bearing member, and the cleaning step can be suitably performed by a cleaning unit.

The cleaning unit is appropriately selected from cleaners known in the art without any limitation, provided that it is capable of removing the toner remained on the latent electrostatic image bearing member. Preferable examples thereof include a magnetic brush cleaner, an electrostatic brush cleaner, a magnetic roller cleaner, a blade cleaner, a brush cleaner, and a web cleaner.

The recycling step is recycling the toner removed in the cleaning step to the developing unit, and the recycling can be suitably carried out by a recycling unit.

The recycling unit is not particularly limited, and examples thereof include conventional conveying units.

The controlling unit is controlling operations of each step, and can be suitably carried out by a controlling unit.

The controlling unit is appropriately selected depending on the intended purpose without any limitation, provided that it is capable of controlling the operations of each step. Examples thereof include devices such as a sequencer, and a computer.

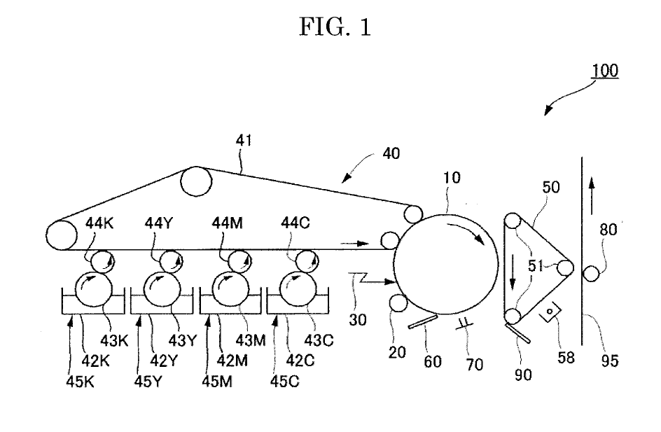

Next, one embodiment of the image forming method carried out by the image forming apparatus is explained with reference to FIG. 1. The image forming apparatus 100 illustrated in FIG. 1 contains a photoconductor drum 10 (may be referred to as a “photoconductor 10” hereinafter) as the latent electrostatic image bearing member, a charging roller 20 as the charging unit, an exposing device 30 as the exposing unit, a developing device 40 as the developing unit, an intermediate transfer member 50, a cleaning device 60 having a cleaning blade, as the cleaning unit, and a diselectrification lamp 70 as the diselectrification unit. The intermediate transfer member 50 is an endless belt, and is designed to rotate in the direction indicated with an arrow by three rollers 51 disposed inside the intermediate transfer member 50 to support the intermediate transfer member 50. Part of the three rollers 51 also functions as a transfer bias roller capable of applying a predetermined transfer bias (primary transfer bias) to the intermediate transfer member 50. In the surrounding area of the intermediate transfer member 50, the cleaning device 90 having the cleaning blade is provided, and the transfer roller 80 serving as the transferring unit, which is capable of applying a transfer bias for transferring (secondary transferring) a developed image (toner image) to transfer paper 95 as a final transfer medium is provided to face the intermediate transfer member 50. In the surrounding area of the intermediate transfer member 50, the corona charger 58, which is configured to apply a charge to the toner image on the intermediate transfer member 50, is provided in the area situated between the contact area of the photoconductor 10 and the intermediate transfer member 50, and the contact area of the intermediate transfer member 50 and the transfer medium 95, in the rotation direction of the intermediate transfer member 50.

The developing device 40 is composed of a developing belt 41 serving as the developer bearing member, and a black developing unit 45K, a yellow developing unit 45Y, a magenta developing unit 45M, and a cyan developing unit 45C, which are provided next to the developing belt 41. Note that, the black developing unit 45K is equipped with a developer container 42K, developer supply roller 43K, and a developing roller 44K, the yellow developing unit 45Y is equipped with a developer container 42Y, a developer supply roller 43Y, and a developing roller 44Y, a magenta developing unit 45M is equipped with a developer container 42M, a developer supply roller 43M, and a developing roller 44M, and the cyan developing unit 45C is equipped with a developer container 42C, a developer supply roller 43C, and a developing roller 44C. Moreover, the developing belt 41 is an endless belt, which is rotatably supported by a plurality of belt rollers, and at part of which is in contact with the photoconductor 10.

In the image forming apparatus 100 illustrated in FIG. 1, for example, the charging roller 20 uniformly charges the photoconductor drum 10. The exposing device 30 exposes the photoconductor drum 10 to light imagewise to form a latent electrostatic image. The latent electrostatic image formed on the photoconductor drum 10 is developed by supplying a toner from the developing device 40, to thereby form a visible image (toner image). The visible image (toner image) is transferred (primary transferred) onto the intermediate transfer member 50 by the voltage applied from the roller 51, and is then further transferred (secondary transferred) onto the transfer paper 95. As a result, the transfer image is formed on the transfer paper 95. Note that, the residual toner on the photoconductor 10 is removed by the cleaning device 60, and the charge of the photoconductor 10 is temporarily removed by the diselectrification lamp 70.

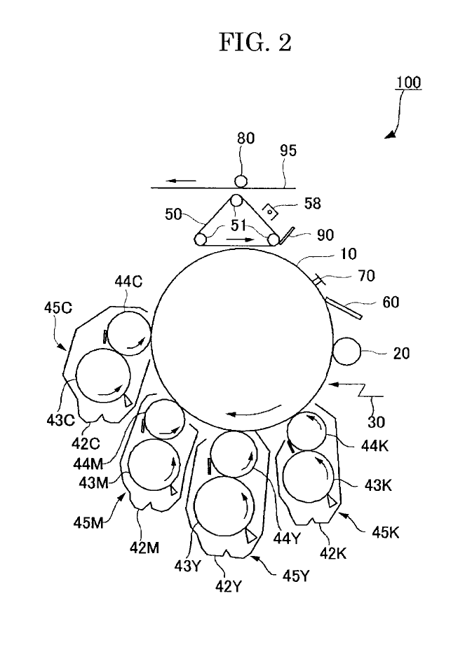

Another embodiment of the image forming method carried out by the image forming apparatus is explained with reference to FIG. 2. The image forming apparatus 100 illustrated in FIG. 2 has the same structure to that of the image forming apparatus 100 of FIG. 1 and has the same functions and effects, provided that the developing belt 41 is not provided, and the black developing unit 45K, the yellow developing unit 45Y, the magenta developing unit 45M, and the cyan developing unit 45C are provided in the surrounding area of the photoconductor 10 to directly face the photoconductor 10. Note that, in FIG. 2, the same units to those in FIG. 1 are the indicated with the same numerical references.

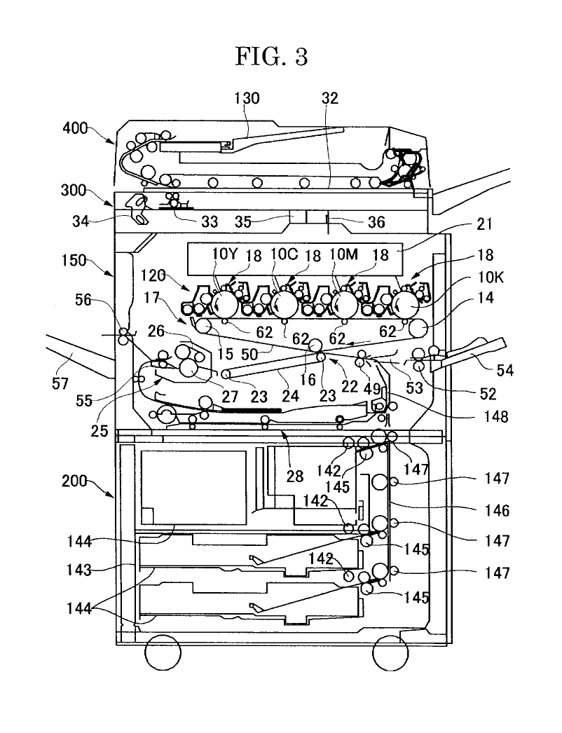

Another embodiment of the image forming method of the present invention carried out by the image forming apparatus is explained with reference to FIG. 3. The image forming apparatus 100 illustrated in FIG. 3 is a tandem color image forming apparatus. The tandem image forming apparatus 100 contains a copier main body 150, a feeding table 200, a scanner 300, and an automatic document feeder (ADF) 400.

In the central part of the copier main body 150, an intermediate transfer member 50 in the form of an endless belt is provided. The intermediate transfer member 50 is rotatably supported by support rollers 14, 15, and 16 in the clockwise direction in FIG. 3. In the surrounding area of the support roller 15, an intermediate transfer member cleaning device 17 configured to remove the residual toner on the intermediate transfer member 50 is provided. To the intermediate transfer member 50 supported by the support roller 14 and the support roller 15, a tandem developing unit 120, in which four image forming units 18, i.e. yellow, cyan, magenta, and black image forming units, are aligned along the traveling direction of the intermediate transfer member 50, is provided. In the surrounding area of the tandem developing unit 120, the exposing device 21 is provided. A secondary transferring device 22 is provided at the opposite side of the intermediate transfer member 50 to the side where the tandem developing unit 120 is provided. In the secondary transfer device 22, a secondary transfer belt 24, which is an endless belt, is supported by a pair of rollers 23, and is designed so that transfer paper transported on the secondary transfer belt 24 and the intermediate transfer member 50 can be in contact with each other. In the surrounding area of the secondary transferring device 22, a fixing device 25 is provided. The fixing device 25 is equipped with a fixing belt 26, which is an endless belt, and a press roller 27 provided to press against the fixing belt 26.

Note that, in the tandem image forming apparatus 100, a sheet reverser 28 configured to reverse the transfer paper to perform image formation on both sides thereof is provided in the surrounding area of the secondary transferring device 22 and the fixing device 25.

Next, formation of a full-color image (color copy) using the tandem developing unit 120 is explained. Specifically, first, a document is set on a document table 130 of the automatic document feeder (ADF) 400. Alternatively, the automatic document feeder (ADF) 400 is opened, a document is set on a contact glass 32 of the scanner 300, and then the ADF 400 is closed.

In the case where the document is set on the ADF 400, once a start switch (not illustrated) is pressed, the document is transported onto the contact glass 32, and then the scanner 300 is driven to scan the document with a first carriage 33 equipped with a light source and a second carriage 34 equipped with a mirror. In the case where the document is set on the contact glass 32, the scanner 300 is immediately driven in the same manner as mentioned. During this scanning operation, light applied from a light source of the first carriage 33 is reflected on the surface of the document, the reflected light from the document is further reflected by a mirror of the second carriage 34, and passed through an image formation lens 35, which is then received by a read sensor 36. In this manner, the color document (color image) is read, and image information of black, yellow, magenta, and cyan is obtained.

The image information of each color, black, yellow, magenta or cyan, is transmitted to respective image forming unit 18 (a black image forming unit, a yellow image forming unit, a magenta image forming unit, and a cyan image forming unit) of the tandem developing unit 120, and by each image forming unit, a respective toner image, i.e. of black, yellow, magenta, or cyan, is formed.

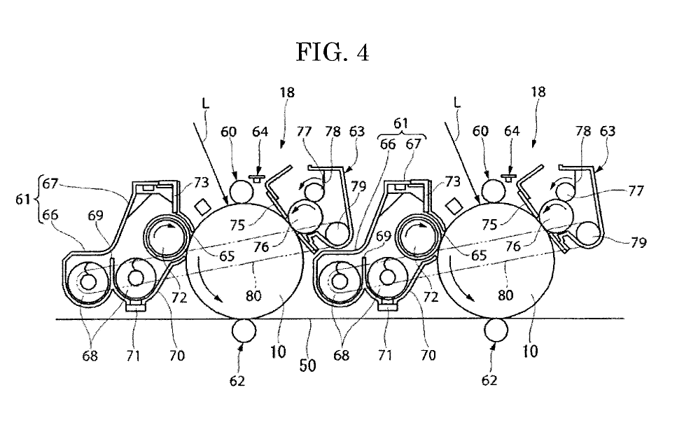

Specifically, each image forming unit 18 (the black image forming unit, the yellow image forming unit, the magenta image forming unit, or the cyan image forming unit) of the tandem developing unit 120 is, as illustrated in FIG. 4, equipped with a photoconductor 10 (black photoconductor 10K, yellow photoconductor 10Y, magenta photoconductor 10M, and cyan latent electrostatic image bearing member 10C), a charging device 60 configured to uniformly charge the photoconductor 10, an exposing device configured to expose the photoconductor with light (L, illustrated in FIG. 4) imagewise corresponding to each color image based on the image information of each color to form a latent electrostatic image corresponding to the image of each color on the latent electrostatic image bearing member, a developing device 61 configured to develop the latent electrostatic image with a respective color toner (a black toner, a yellow toner, a magenta toner, or a cyan toner) to form a toner image of each color toner, a transfer charger 62 configured to transfer the toner image onto an intermediate transfer member 50, a photoconductor cleaning device 63, and diselectrification unit 64. The image forming units can form single color images of respective color (a black image, a yellow image, a magenta image, and a cyan image) corresponding to the respective image information of respective color. The black image, yellow image, magenta image, and cyan image formed in this manner are transferred to the intermediate transfer member 50 rotatably supported by the support rollers 14, 15, and 16 in the following manner. Specifically, the black image formed on the black photoconductor 10K, the yellow image formed on the yellow photoconductor 10Y, the magenta image formed on the magenta photoconductor 10M, and the cyan image formed on the cyan photoconductor 10C are successively transferred (primary transferred) onto the intermediate transfer member 50. On the intermediate transfer member 50, the black image, the yellow image, the magenta image, and the cyan image are superimposed to form a composite color image (a color transfer image).

In the feeding table 200, meanwhile, one of the feeding rollers 142 is selectively rotated to eject a sheet (recording paper) from one of multiple feeder cassettes 144 of a paper bank 143, the ejected sheets are separated one by one by a separation roller 145 to send to a feeder path 146, and then transported by a transport roller 147 into a feeder path 148 within the copier main body 150. The sheet transported in the feeder path 148 is then bumped against a registration roller 49 to stop. Alternatively, sheets (recording paper) on a manual-feeding tray 51 are ejected by rotating a feeding roller 150, separated one by one by a separation roller 52 to guide into a manual feeder path 53, and then bumped against the registration roller 49 to stop. Note that, the registration roller 49 is generally earthed at the time of the use, but it may be biased for removing paper dust of the sheet.

Next, the registration roller 49 is rotated synchronously with the movement of the composite color image (color transfer image) superimposed on the intermediate transfer member 50, to thereby send the sheet (recording paper) between the intermediate transfer member 50 and the secondary transferring device 22. The composite color image (color transfer image) is then transferred (secondary transferred) to the sheet (recording paper) by the secondary transferring device 22, to thereby form the color image on the sheet (recording paper). Note that, after transferring the image, the residual toner on the intermediate transfer member 50 is cleaned by the intermediate transfer member cleaning device 17.

The sheet (recording paper) on which the color image has been transferred is transported by the secondary transfer device 22 to send to the fixing device 25. In the fixing device 25, the composite color image (color transfer image) is fixed on the sheet (recording paper) by heat and pressure applied. Thereafter, the sheet (recording paper) is changed its traveling direction by a switch craw 55, ejected by an ejecting roller 56, and then stacked on an output tray 57. Alternatively, the sheet (recording paper) is changed its traveling direction by the switch craw 55, reversed by the sheet reverser 28 to again send to a transfer position, to thereby record an image on the back side thereof. Then, the sheet (recording paper) is ejected by the ejecting roller 56, and stacked on the output tray 57.

The aforementioned image forming apparatus and image forming method use the toner of the present invention, which has small particle diameters, a narrow particle size distribution, and is spherical in the shape, and therefore high quality images can be efficiently obtained.

### EXAMPLES

Examples of the present invention are explained hereinafter, but Examples shall not be construed as to limit the scope of the present invention.

### Example 1

### Adhesive Base Generation Step

Toner base particles were produced in the following manner, followed by producing a toner.

### —Preparation of Solution or Dispersion Liquid of Toner Materials—

### —Synthesis of Unmodified Polyester (Low Molecular Polyester)—

A reaction tank equipped with a cooling tube, a stirrer, and a nitrogen-inlet tube was charged with 220 parts by mass of bisphenol A ethylene oxide (2 mol) adduct, 561 parts by mass of bisphenol A propylene oxide (3 mol) adduct, 218 parts by mass of terephthalic acid, 48 parts by mass of adipic acid, and 2 parts by mass of dibutyl tin oxide, and the resulting mixture was allowed to react for 8 hours at 230° C. under the atmospheric pressure. Subsequently, the reaction liquid was allowed to react for 5 hours under the reduced pressure of 10 mmHg to 15 mmHg. Then, 45 parts by mass of trimellitic anhydride was added to the reaction tank, and the mixture was allowed to react for 2 hours at 180° C. under the atmospheric pressure, to thereby synthesize unmodified polyester.

The obtained unmodified polyester had the number average molecular weight (Mn) of 2,500, weight average molecular weight (Mw) of 6,700, glass transition temperature (Tg) of 43° C., and acid value of 25 mgKOH/g.

### —Preparation of Master Batch (MB)—

By means of HENSCHEL MIXER (manufactured by Nippon Cole & Engineering Co., Ltd.), 40 parts by mass of carbon black (REGAL 400R, manufactured by Cabot Corporation) as a colorant, 40 parts by mass of a polyester resin (RS801, manufactured by Sanyo Chemical Industries, Ltd., acid value: 10 mgKOH/g, weight average molecular weight (Mw): 20,000, glass transition temperature (Tg): 64° C.), and 30 parts by mass of water were mixed. The resulting mixture was kneaded for 45 minutes at 130° C. with a two-roll kneader, and then was rolled and cooled, followed by pulverized with a pulverizer (manufactured by Hosokawa Micron Corporation) into particles having a diameter of 1 mm, to thereby prepare a master batch.

### —Preparation of Organic Solvent Phase—

A reaction vessel equipped with a stirring bar and a thermometer was charged with 378 parts by mass of the unmodified polyester, 110 parts by mass of carnauba wax, 22 parts by mass of a charge controlling agent (CCA, salicyclic acid metal complex E-84, manufactured by Orient Chemical Industries, Ltd.), and 947 parts by mass of ethyl acetate, and the resulting mixture was heated to 80° C. with stirring, to thereby dissolve the carnauba wax. After leaving the resulting solution to stand for 5 hours at 80° C., the solution was cooled to 30° C. over 1 hour, to precipitate the carnauba wax. Subsequently, 500 parts by mass of the master batch and 500 parts by mass of ethyl acetate were added to the reaction vessel, and the resulting mixture was mixed for 1 hour, to thereby obtain a raw material solution.

The obtained raw material solution (1,324 parts by mass) was transferred to a reaction vessel, and the carbon black and the carnauba wax were dispersed by means of a bead mill (ULTRA VISCOMILL, manufactured by AIMEX Co., Ltd.) under the conditions: a liquid feed rate of 1 kg/hr, disc circumferential velocity of 6 m/s, 0.5 mm-zirconia beads packed to 80% by volume, and 3 passes. Subsequently, 1,324 parts by mass of a 65% by mass ethyl acetate solution of the unmodified polyester was added to the wax dispersion liquid, and the resulting mixture was dispersed by the bead mill once (one pass) under the conditions described above, to thereby obtain an organic solvent phase.

The solid content of the obtained organic solvent phase (measuring conditions: heated at 130° C., for 30 minutes) was 53% by mass.

### —Synthesis of Prepolymer—

A reaction vessel equipped with a cooling tube, a stirrer, and a nitrogen-inlet tube was charged with 682 parts by mass of bisphenol A ethylene oxide (2 mol) adduct, 81 parts by mass of bisphenol A propylene oxide (2 mol) adduct, 283 parts by mass of terephthalic acid, 22 parts by mass of trimellitic anhydride, and 2 parts by mass of dibutyl tin oxide, and the resulting mixture was allowed to react for 8 hours at 230° C. Subsequently, the resultant was further allowed to react for 5 hours under the reduced pressure of 10 mmHg to 15 mmHg, to thereby synthesize intermediate polyester.

The obtained intermediate polyester had the number average molecular weight (Mn) of 2,100, weight average molecular weight (Mw) of 9,500, glass transition temperature (Tg) of 55° C., acid value of 0.5 mgKOH/g, and hydroxyl value of 51 mgKOH/g.

Next, a reaction vessel equipped with a cooling tube, a stirrer, and a nitrogen-inlet tube was charged with 410 parts by mass of the intermediate polyester, 89 parts by mass of isophorone diisocyanate, and 500 parts by mass of ethyl acetate, and the resulting mixture was allowed to react for 5 hours at 100° C., to thereby synthesize a prepolymer (the polymer reactable with the active hydrogen group-containing compound).

The free isocyanate content in the obtained prepolymer was 1.35% by mass.

### —Synthesis of Ketimine (The Active Hydrogen Group-Containing Compound)—

A reaction vessel equipped with a stirring bar and a thermometer was charged with 170 parts by mass of isophorone diamine, and 75 parts by mass of methyl ethyl ketone, and the resulting mixture was allowed to react for 5 hours at 50° C., to thereby a ketimine compound (the active hydrogen group-containing compound).

The amine value of the ketimine compound (the active hydrogen group-containing compound) was 418.

A reaction vessel was charged with 648 parts by mass of the organic solvent phase, 154 parts by mass of the prepolymer, and 6.6 parts by mass of the ketimine compound, and the resulting mixture was mixed for 1 minute at 5,000 rpm by means of TK Homomixer (manufactured by PRIMIX Corporation), to thereby prepare a toner material solution or dispersion liquid.

### —Preparation of Aqueous Medium—

### —Preparation of Particle Dispersion Liquid—

A reaction vessel equipped with a stirring bar, a stirring blade, and a thermometer was charged with 683 parts by mass of water, 11 parts by mass of a sodium salt of sulfuric acid ester of methacrylic acid-ethylene oxide adduct (ELEMINOL RS-30, manufactured by Sanyo Chemical Industries, Ltd.), 83 parts by mass of styrene, 83 parts by mass of methacrylic acid, 110 parts by mass of butyl acrylate, and 1 part by mass of ammonium persulfate, and the resulting mixture was stirred for 15 minutes at 400 rpm, to thereby obtain a white emulsion. The emulsion was heated to increase the internal system temperature to 75° C., to thereby allow the emulsion to react for 5 hours. Subsequently, 30 parts by mass of a 1% by mass ammonium persulfate aqueous solution was added, and the resulting mixture was aged for 5 hours at 75° C., to thereby prepare an aqueous dispersion liquid (particle dispersion liquid) of vinyl resin particles (a copolymer of styrene/methacrylic acid/butyl acrylate/a sodium salt of sulfuric acid ester of methacrylic acid-ethylene oxide adduct).

The volume average particle diameter of the particles contained in the obtained particle dispersion liquid was measured by means of a particle size distribution analyzer using laser scattering (LA-920, manufactured by HORIBA, Ltd.), and the result thereof was 40 nm. Moreover, part of the resin dispersion liquid was dried to separate a resin component thereof, and the glass transition temperature (Tg) of the resin component was measured. As a result, the glass transition temperature (Tg) was 59° C. Moreover, the weight average molecular weight (Mw) thereof was measured, and the result was 150,000.

Ion-exchanged water (993 parts by mass), 83 parts by mass of the particle dispersion liquid, 2.5 parts by mass of a 48.5% by mass sodium dodecyldiphenyl ether disulfonate aqueous solution (ELEMINOL MON-7, manufactured by Sanyo Chemical Industries, Ltd.), 37 parts by mass of a 10% sodium chloride aqueous solution, and 90 parts by mass of ethyl acetate were mixed and stirred, to thereby obtain a milky white liquid (aqueous medium).

### —Preparation of Emulsion or Dispersion Liquid—

To 809 parts by mass of the toner material solution or dispersion, 1,200 parts by mass of the aqueous medium was added, and the resulting mixture was mixed for 20 minutes at 13,000 rpm by means of the TK Homomixer, to thereby prepare an emulsion or dispersion liquid (emulsified slurry). Note that, the preparation of the emulsion or dispersion liquid was carried out in the batch system.

### —Addition of Aqueous Medium—

A reaction vessel equipped with a stirrer was charged with 100 parts by mass of the emulsion or dispersion liquid just after prepared. While stirring the emulsion or dispersion liquid, 20 parts by mass (20% by volume relative to a total amount of the emulsion or dispersion liquid) of ion-exchanged water was added, and the resulting mixture was emulsified or dispersed, to thereby prepare an emulsified slurry.

Next, a reaction vessel equipped with a stirrer and a thermometer was charged with the emulsified slurry, and the solvent was removed from the emulsified slurry for 8 hours at 30° C., followed by aging for 4 hours at 45° C., to thereby obtain a dispersion slurry.

### —Washing and Drying—

After filtering 100 parts by mass of the dispersion slurry under the reduced pressure, 300 parts by mass of ion-exchanged water was added to the resulting filtration cake, and the mixture was then mixed (for 10 minutes at 12,000 rpm) by means of TK Homomixer, followed by filtering the mixture. This series of the operations was performed 3 times, to thereby obtain a final filtration cake.

The obtained final filtration cake was dried for 48 hours at 45° C. by an air-circulating drier, and the resultant was passed through a sieve with a mesh size of 75 μm, to thereby obtain toner base particles of Example 1.

### —External Additive Treatment—

To 100 parts by mass of the toner base particles obtained in Example 1, 0.7 parts by mass of hydrophobic silica, and 0.3 parts by mass of hydrophobic titanium oxide were added, and the resultant was mixed by means of HENSCHEL MIXER (manufactured by Nippon Cole & Engineering Co., Ltd.), to thereby obtain a toner of Example 1.

### Example 2

A toner of Example 2 was produced in the same manner as in Example 1, provided that in the preparation of the aqueous medium of Example 1, 993 parts by mass of the ion-exchanged water, and 2.5 parts by mass of the 48.5% sodium dodecyldiphenyl ether disulfonate aqueous solution were respectively replaced with 920 parts by mass of ion-exchanged water, and 75 parts by mass of the 48.5% by mass sodium dodecyldiphenyl ether disulfonate aqueous solution.

### Example 3

A toner of Example 3 was produced in the same manner as in Example 1, provided that in the preparation of the aqueous medium of Example 1, 993 parts by mass of the ion-exchanged water, and 2.5 parts by mass of the 48.5% sodium dodecyldiphenyl ether disulfonate aqueous solution were respectively replaced with 991 parts by mass of ion-exchanged water, and 5 parts by mass of the 48.5% by mass sodium dodecyldiphenyl ether disulfonate aqueous solution.

### Example 4

A toner of Example 4 was produced in the same manner as in Example 1, provided that in the preparation of the aqueous medium of Example 1, 993 parts by mass of the ion-exchanged water, and 2.5 parts by mass of the 48.5% sodium dodecyldiphenyl ether disulfonate aqueous solution were respectively replaced with 932 parts by mass of ion-exchanged water, and 62 parts by mass of the 48.5% by mass sodium dodecyldiphenyl ether disulfonate aqueous solution.

### Example 5

A toner of Example 5 was produced in the same manner as in Example 1, provided that in the preparation of the aqueous medium of Example 1, 993 parts by mass of the ion-exchanged water, and 2.5 parts by mass of the 48.5% sodium dodecyldiphenyl ether disulfonate aqueous solution were respectively replaced with 988 parts by mass of ion-exchanged water, and 7.5 parts by mass of the 48.5% by mass sodium dodecyldiphenyl ether disulfonate aqueous solution.

### Example 6

A toner of Example 6 was produced in the same manner as in Example 1, provided that in the preparation of the aqueous medium of Example 1, 993 parts by mass of the ion-exchanged water, and 2.5 parts by mass of the 48.5% sodium dodecyldiphenyl ether disulfonate aqueous solution were respectively replaced with 965 parts by mass of ion-exchanged water, and 32.5 parts by mass of the 48.5% by mass sodium dodecyldiphenyl ether disulfonate aqueous solution.

### Example 7

A toner of Example 7 was produced in the same manner as in Example 1, provided that in the preparation of the aqueous medium of Example 1, 993 parts by mass of the ion-exchanged water, and 2.5 parts by mass of the 48.5% sodium dodecyldiphenyl ether disulfonate aqueous solution were respectively replaced with 995 parts by mass of ion-exchanged water, and 2 parts by mass of the 48.5% by mass sodium dodecyldiphenyl ether disulfonate aqueous solution.

### Example 8

A toner of Example 8 was produced in the same manner as in Example 1, provided that in the preparation of the aqueous medium of Example 1, 993 parts by mass of the ion-exchanged water, and 2.5 parts by mass of the 48.5% sodium dodecyldiphenyl ether disulfonate aqueous solution were respectively replaced with 916 parts by mass of ion-exchanged water, and 79.5 parts by mass of the 48.5% by mass sodium dodecyldiphenyl ether disulfonate aqueous solution.

### Example 9

### Preparation of Toner Base Particles

Toner base particles of Example 9 were obtained in the same manner as in Example 1, provided that a crystalline polyester resin synthesized in the following manner was added.

### —Synthesis of Crystalline Polyester Resin—

A 5 L four-necked flask equipped with a nitrogen-introducing tube, a condenser, a stirrer, and a thermocouple was charged with 2,070 g of 1,4-butanediol, 2,535 g of fumaric acid, 291 g of trimellitic anhydride, and 4.9 g of hydroquinone, and the resulting mixture was allowed to react for 5 hours at 160° C. Thereafter, the resultant was heated to 200° C. to be reacted for 1 hours, and then was further allowed to react for 1 hour at 8.3 kPa, to thereby obtain a crystalline polyester resin.

The DSC endothermic peak temperature thereof was 123° C. The molecular weight distribution of the orthodichlorobenzene soluble component thereof as measured by GPC, Mw/Mn, was 2.96, where the weight average molecular weight (Mw) thereof was 2,100, and the number average molecular weight (Mn) thereof was 710. Moreover, in the IR absorption spectrum thereof, the absorption based on δCH (out-of-plane bending vibrations) of olefin was measured, which was 967 cm⁻¹.

### —Preparation of Crystalline Polyester Resin Dispersion Liquid—

A 2 L metal vessel was charged with 100 g of the crystalline polyester resin, and 400 g of ethyl acetate, and the resulting mixture was heated at 79° C. to dissolve the crystalline polyester resin therein, followed by cooling in an ice-water bath. To this, 500 mL of glass beads (3 mm in diameter) were added, and the resultant was subjected to pulverization for 10 hours by means of a batch-type sand mill (manufactured by Kanpe Hapio Co., Ltd.), followed by removing part of the ethyl acetate, to thereby prepare a crystalline polyester resin dispersion liquid having the volume average particle diameter of 0.4 μm, and a solid content of 50% by mass.

Toner base particles of Example 9 were obtained in the same manner as in Example 1, provided that in the preparation of the toner material solution or dispersion liquid of Example 1, 200 parts by mass of the crystalline polyester resin dispersion liquid was added to the wax dispersion liquid together with 1,324 parts by mass of the 65% by mass ethyl acetate solution of the unmodified polyester resin, and part of the ethyl acetate was evaporated to adjust the solid content of the toner material solution or dispersion liquid to 50% by mass.

### —External Additive Treatment—

To the toner base particles obtained in Example 9, the external additives were added in the same manner as the case of the toner base particles of Example 1, to thereby produce a toner of Example 9.

### Example 10

A toner of Example 10 was obtained in the same manner as in Example 9, provided that in the preparation of the aqueous medium of Example 9, 993 parts by mass of the ion-exchanged water, and 2.5 parts by mass of the 48.5% by mass sodium dodecyldiphenyl ether disulfonate aqueous solution were respectively changed to 920 parts by mass of ion-exchanged water, and 75 parts by mass of the 48.5% by mass sodium dodecyldiphenyl ether disulfonate aqueous solution.

### Example 11

A toner of Example 11 was obtained in the same manner as in Example 9, provided that in the preparation of the aqueous medium of Example 9, 993 parts by mass of the ion-exchanged water, and 2.5 parts by mass of the 48.5% by mass sodium dodecyldiphenyl ether disulfonate aqueous solution were respectively changed to 970 parts by mass of ion-exchanged water, and 25 parts by mass of the 48.5% by mass sodium dodecyldiphenyl ether disulfonate aqueous solution.

### Example 12

A toner of Example 12 was obtained in the same manner as in Example 1, provided that in the preparation of the aqueous medium of Example 1, 993 parts by mass of the ion-exchanged water, and 2.5 parts by mass of the 48.5% by mass sodium dodecyldiphenyl ether disulfonate aqueous solution were respectively changed to 883.5 parts by mass of ion-exchanged water, and 112 parts by mass of the 48.5% by mass sodium dodecyldiphenyl ether disulfonate aqueous solution.

### Example 13

A toner of Example 13 was obtained in the same manner as in Example 9, provided that in the preparation of the aqueous medium of Example 9, 993 parts by mass of the ion-exchanged water, and 2.5 parts by mass of the 48.5% by mass sodium dodecyldiphenyl ether disulfonate aqueous solution were respectively changed to 883.5 parts by mass of ion-exchanged water, and 112 parts by mass of the 48.5% by mass sodium dodecyldiphenyl ether disulfonate aqueous solution.

### Comparative Example 1

A toner of Comparative Example 1 was produced in the same manner as in Example 1, provided that, in the preparation of the aqueous medium of Example 1, 37 parts by mass of the 10% sodium chloride aqueous solution was replaced with 37 parts by mass of ion-exchanged water.

### Comparative Example 2

A toner of Comparative Example 2 was produced in the same manner as in Example 2, provided that in the preparation of the aqueous medium of Example 2, 37 parts by mass of the 10% sodium chloride aqueous medium was changed to 37 parts by mass of ion-exchanged water.

### Comparative Example 3

A toner of Comparative Example 3 was produced in the same manner as in Comparative Example 2, provided that in the preparation of the aqueous medium of Comparative Example 2, 957 parts by mass of the ion-exchanged water, and 83 parts by mass of the resin particles were respectively changed to 913 parts by mass of ion-exchanged water, and 125 parts by mass of the resin particles.

### Comparative Example 4

A toner of Comparative Example 4 was produced in the same manner as in Comparative Example 2, provided that in the preparation of the aqueous medium of Comparative Example 2, 957 parts by mass of the ion-exchanged water, and 83 parts by mass of the resin particles were respectively changed to 978.2 parts by mass of ion-exchanged water, and 61 parts by mass of the resin particles.

Next, developers of Examples 1 to 13 and Comparative Examples 1 to 4 were each prepared by a conventional method using 5% by mass of the respective toner selected from the toners of Examples 1 to 13 and Comparative Examples 1 to 4, which had been subjected to the external additive treatment, and 95% by mass of Cu—Zn ferrite carrier coated with a silicone resin and having the average particle diameter of 40 μm.

The obtained developers were each evaluated in terms of the (a) fixing ability (minimum fixing temperature), (b) heat resistant storage stability, (c) durability, (d) charging characteristics, and (e) resin particle amount, in the following manners. The results are presented in Table 1.

### (a) Fixing Ability (Minimum Fixing Temperature)

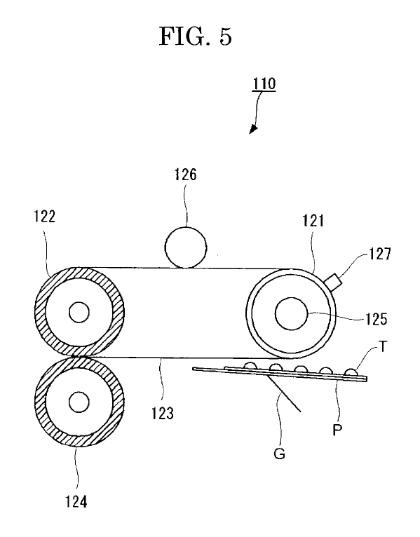

The fixing ability (minimum fixing temperature) was evaluated using an image forming apparatus equipped with a belt fixing device 110 illustrated in FIG. 5.

The belt fixing device 110 is equipped with a heating roller 121, a fixing roller 122, a fixing belt 123, a press roller 124.

The fixing belt 123 is supported with the heating roller 121 and the fixing roller 122, which are both rotatably provided in the inner side of the fixing belt 123, and is heated to the predetermined temperature by the heating roller 121. A heat source 125 is provided inside the heating roller 121, and the temperature of the heating roller 121 is set and adjusted by the temperature sensor 127, which is provided adjacent to the heating roller 121. The fixing roller 122 is rotatably provided at the inner side of the fixing belt 123 to be contact with the inner surface of the fixing belt 123. The heating roller 124 is rotatably provided at the outer side of the fixing belt 123 so that the fixing roller 122 is in contact with the outer surface of the fixing belt 123.

In the fixing belt device 110, first, a recording medium (sheet) P, on which a toner image to be fixed has been formed, is transported to the heating roller 121. Then, the toner T on the sheet P is heated to be in a melted state by the heating roller 121, which has been heated to the predetermined temperature by the function of the heat source 125 therein, and the fixing belt 123. In this state, the sheet P is inserted into a nip formed between the fixing roller 122 and the press roller 124. The sheet P inserted into the nip is brought into contact with a surface of the fixing belt 123, which is rotated interlocking with the rotation of the fixing roller 122 and the press roller 124, and is pressed with the pressure applied from the press roller 124 as the sheet P passed through the nip, to thereby fix the toner T on the sheet P. Subsequently, the sheet P, on which the toner T has been fixed, passes through the space between the fixing roller 122 and the press roller 124, is released from the fixing belt 123, and is transported to a tray (not illustrated) through a guide G. Note that, the fixing belt 123 is cleaned with a cleaning roller 126.

In the belt fixing device illustrated in FIG. 5, fixing was performed with the fixing roller 122, press roller 124, heat roller 121, and fixing belt 123 under the following fixing conditions, i.e., the belt tension of 1.5 kg/piece, belt speed of 170 mm/sec, and nip width of 10 mm.

The fixing roller 122 is a roller formed of silicone foam, having a diameter of 38 mm, and having Asker C hardness of about 30 degrees. The press roller 124 is an aluminum roller having a diameter of 50 mm and a radial thickness of 2 mm, formed by covering a core (formed of iron, a radial thickness of 1 mm) having a diameter of 48 mm with a PFA tube, and covering a surface of the PFA layer with a silicone rubber layer having a thickness of 1 mm. The fixing belt 123 has a belt diameter of 60 mm and a belt width of 310 mm, contains a nickel belt base having a thickness of about 40 μm, on a surface of which a silicone rubber releasing layer having a thickness of about 150 μm is provided, and is supported with the heat roller 121 and the fixing roller 122.

### <Minimum Fixing Temperature>

The image forming apparatus equipped with the belt fixing device illustrated in FIG. 5 was used. An image was formed using an evaluation device, which was a turned image forming apparatus (IPSIO Color 8100, manufactured by Ricoh Company Limited) to employ an oil-less fixing system. Thick paper (Copy Printing Sheet <135>, manufactured by NBS Ricoh) was set, and the apparatus was adjusted so that a solid image was developed with the toner to give the deposition amount of 1.0 mg/cm²±0.1 mg/cm². The fixing roller temperature at which the residual rate of the image density was 70% or higher after scraping the obtained fixed image with a pad was determined as the maximum fixing temperature.

### [Evaluation Criteria]

A: The minimum fixing temperature was lower than 120° C.

B: The minimum fixing temperature was 120° C. or higher but lower than 140° C.

C: The minimum fixing temperature was 140° C. or higher

### (b) Heat Resistant Storage Stability

The toner was weight by 10 mg. Each toner was placed into a 20 mL glass bottle, and the glass bottle was tapped 100 times, followed by leaving the glass bottle in a thermostat set at the temperature of 55° C., and the humidity of 80% RH, for 24 hours. The resulting toner was subjected to a penetration degree test (JIS K2235-1991) to measure a penetration degree (%). Moreover, a penetration degree of the toner, which had been stored in the low temperature low humidity environment (10° C., 15% RH) was also evaluated in the same manner. The smaller value of the penetration degree between the high temperature and high humidity environment, and the low temperature and low humidity environment was used. Note that, the larger the value of the penetration degree means more excellent heat resistant storage stability

### [Evaluation Criteria]

A: The penetration degree was 25 mm or greater.

B: The penetration degree was 15 mm or greater, but less than 25 mm.

C: The penetration degree was less than 15 mm

### (c) Durability

The image forming apparatus equipped with the belt fixing device illustrated in FIG. 5 was used. Using the evaluation device, which was a turned image forming apparatus (IPSIO Color 8100, manufactured by Ricoh Company Limited) to employ an oil-less fixing system, a solid image having a developer deposition amount of 0.4 mg/cm²±0.1 mg/cm² was formed on transfer paper (Type 6000, manufactured by Ricoh Company Limited) with the fixing roller surface temperature of 160° C.±2° C. The image density of the obtained solid image was measured at randomly selected 3 spots by means of a spectrometer (938 spectrodensitometer, manufactured by X-Rite), and an average value thereof was determined as the image density value.

After outputting 100,000 sheets of the image chart having an imaging area ratio of 35% by means of the image forming apparatus, a solid image having the developer deposition amount of 0.4 mg/cm²±0.1 mg/cm² was formed on the transfer paper with the fixing roller surface temperature of 160° C.±2° C. The image density of the obtained solid image was measured at randomly selected 3 spots by means of the spectrometer. The average values of the image density values measured at the 3 spots was determined as the image density value.

### [Evaluation Criteria]

A: Difference in the image density value between before and after the running was less than 0.1.

B: Difference in the image density value between before and after the running was less than 0.5 but 0.1 or more.

C: Difference in the image density value between before and after the running was 0.5 or more.

### (d) Charging Characteristics

In the laboratory having the temperature of 20° C., and humidity of 50% RH, a stainless steel pot was charged with 100 parts by mass of the carrier, and 5 parts by mass of the toner of the present invention, and the mixture was rotated and mixed on a ball mill stand at the constant rotational number. The charged amount (μC/g) of the developer after 10 minutes from the start of the rotation was measured by means of a blow-off device

### [Evaluation Criteria]

A: The charged amount was in the range of −20 μc/g to −35 μc/g.

B: The charged amount was in the range of −10 μc/g to −20 μc/g, or in the range of −35 μc/g to −45 μc/g.

C: The charged amount was outside any of the aforementioned ranges.

### (e) Resin Particle Amount

The styrene monomer originated from the resin particles of a styrene-acryl copolymer was used as a standard, and the toner was thermally decomposed to measure an amount of the styrene monomer in the pyrolyzate. Then, the amount of the resin particles in the toner was calculated.

Specifically, resin particles of a styrene-acryl copolymer, formulation of which had been known, was used as a standard, the resin particles of the styrene-acryl copolymer was added to the toner particles, so that the amount of the resin particles in the toner particles was to be 0.01% by mass, 0.10% by mass, 1.00% by mass, 3.00% by mass, and 10.0% by mass.

Each of the obtained model toners the formulation of which had been known was thermally decomposed at 590° C. for 12 seconds, and the resulting pyrolyzate was analyzed by means of the following measuring device under the following measuring conditions, to determine a peak area of the styrene monomer for each toner. Then, an amount of the resin particles in the toner was calculated.

### [Measuring Device and Measuring Conditions]

Analysis device: Pyrolysis gas chromatograph
Mass analyzer main body: QR-5000 (manufactured by Shimadzu Corporation)
Attached pyrolysis furnace: JHP-3S (manufactured by Japan Analytical Industry Co., Ltd.)
Pyrolysis temperature: 590° C.×12 seconds

### Column: DB-1 (L=30 m, I.D.=0.25 mm, Film=0.25 μm)

Column temperature: 40° C. (maintained for 2 minutes) to 300° C. (heating rate of 10° C./min)
Vaporizing chamber temperature: 300° C.

### [Evaluation Criteria]

A: 95% or greater relative to the formulated amount

B: 70% or greater but less than 95%, relative to the formulated amount

C: less than 70% relative to the formulated amount

TABLE 1

| | | | Formulated | | |
|---|---|---|---|---|---|
| | | | amount | | |
| | Surfactant | | of resin | Crystalline | Resin |
| | amount | Inorganic | particles | resin in | particle |
| | (mass %) | salt | (mass %) | binder resin | amount |
| Ex. 1 | 0.1 | Present | 2.05 | Not present | B |
| Ex. 2 | 3 | Present | 2.05 | Not present | B |
| Ex. 3 | 0.2 | Present | 2.05 | Not present | B |
| Ex. 4 | 2.5 | Present | 2.05 | Not present | B |
| Ex. 5 | 0.3 | Present | 2.05 | Not present | A |
| Ex. 6 | 1.3 | Present | 2.05 | Not present | A |
| Ex. 7 | 0.08 | Present | 2.05 | Not present | B |
| Ex. 8 | 3.2 | Present | 2.05 | Not present | B |
| Ex. 9 | 0.1 | Present | 2.05 | Present | B |
| Ex. 10 | 3 | Present | 2.05 | Present | B |
| Ex. 11 | 1 | Present | 2.05 | Present | A |
| Ex. 12 | 4.5 | Present | 2.05 | Not present | B |
| Ex. 13 | 4.5 | Present | 2.05 | Present | B |
| Comp. | 0.1 | Not present | 2.05 | Not present | C |
| Ex. 1 | | | | | |
| Comp. | 3 | Not present | 2.05 | Not present | C |
| Ex. 2 | | | | | |
| Comp. | 3 | Not present | 3.1 | Not present | C |
| Ex. 3 | | | | | |
| Comp. | 3 | Not present | 1.5 | Not present | C |
| Ex. 4 | | | | | |

| | Evaluation item | | | | |
|---|---|---|---|---|---|
| | Min. | | | Charging | Total |
| | Fixing | Storage | Durability | characteristics | evaluation |
| Ex. 1 | B | B | B | B | 4 |
| Ex. 2 | B | B | B | B | 4 |
| Ex. 3 | B | A | B | B | 3 |
| Ex. 4 | B | A | B | B | 3 |
| Ex. 5 | B | A | A | B | 2 |
| Ex. 6 | B | A | A | B | 2 |
| Ex. 7 | B | C | B | B | 5 |
| Ex. 8 | B | C | B | B | 5 |
| Ex. 9 | A | A | B | B | 2 |
| Ex. 10 | A | A | B | B | 2 |
| Ex. 11 | A | A | A | A | 1 |
| Ex. 12 | B | C | B | B | 5 |
| Ex. 13 | A | C | B | B | 5 |
| Comp. Ex. 1 | B | C | C | C | 6 |
| Comp. Ex. 2 | B | C | C | B | 6 |
| Comp. Ex. 3 | C | C | B | B | 6 |
| Comp. Ex. 4 | B | C | C | B | 6 |

In Table 1 above, the standards of the total evaluation are as follows:

1: Extremely excellent

2: Excellent

3: Excellent compared to a conventional product

4: Usable

5: Can be somehow used on practice

6: Cannot be used on practice

The following points are clear from the results presented in Table 1. Specifically, in Examples 1 to 8, the effective deposition of the resin particles to the toner was accelerated by adding the inorganic salt to the aqueous medium, and thus the toner the durability and storage stability of which had been improved was obtained. Moreover, the storage stability and durability were further improved by regulating the amount of the surfactant for use. In Examples 9 to 10, the sharp melt property was provided to the toner particles, as the binder resin contained the crystalline resin, and therefore the toner having lower minimum fixing temperature was obtained. In Example 11, the surfactant and the resin particles were effectively deposited on the surfaces of the toner particles by adding the inorganic salt to the aqueous medium, adding the crystalline resin to the binder resin, and using a suitable amount of the surfactant, and the toner having extremely excellent low temperature fixing ability, storage stability, durability, and charging characteristics was obtained. In Examples 12 to 13, it was possible to sufficiently fix the toner at low fixing temperature, even when the amount of the surfactant was 4.5% by mass, and moreover, the toner having excellent various properties, such as storage stability, durability, and charging characteristics was obtained.

It has been found that the toner of the present invention can reduce an amount of a surfactant for use, and can be sufficiently fixed at low fixing temperature, and have excellent various properties, such as storage stability, durability, and charging characteristics. Accordingly, the toner of the present invention is suitably used for formation of high quality images. The developer, toner container, process cartridge, image forming apparatus, and image forming method using the toner of the present invention can be suitably used for formation of high quality images.

The embodiments of the present invention are, for example, as follows:

<1> A toner containing:

toner base particles, in each of which a colorant and a releasing agent are encapsulated with a binder resin, where the toner base particles are obtained by the method containing:

mixing and emulsifying a mixture containing the binder resin, the colorant, the releasing agent, and an organic solvent in an aqueous medium in the presence of resin particles,

wherein the aqueous medium contains a surfactant and an inorganic salt.

<2> The toner according to <1>, wherein the surfactant is contained in an amount of 0.1% by mass to 4.5% by mass relative to the aqueous medium.
<3> The toner according to <1> or <2>, wherein the surfactant is an anionic surfactant.
<4> The toner according to <3>, wherein the surfactant is alkyl sulfate or alkyl sulfonate.
<5> The toner according to any one of <1> to <4>, wherein an amount of the inorganic salt used in the aqueous medium is 0.01% by mass to 20% by mass relative to the aqueous medium.
<6> The toner according to any one of <1> to <5>, wherein the inorganic salt contains chloride, nitrate, sulfate, or carbonate of one inorganic material selected from the group consisting of Na, K, and Ca.
<7> The toner according to any one of <1> to <6>, wherein an amount of the resin particles for use is in the range of 0.5 parts by mass to 5.0 parts by mass relative to 100 parts by mass of the toner.
<8> The toner according to any one of <1> to <7>, wherein the binder resin contains a crystalline resin.
<9> A method for producing a toner, containing:

mixing and emulsifying a mixture containing a binder resin, a colorant, a releasing agent, and an organic solvent in an aqueous medium in the presence of resin particles, to form toner base particles in each of which the colorant and the releasing agent are encapsulated with the binder resin,

wherein the aqueous medium contains a surfactant and an inorganic salt.

<10> The method according to <9>, further containing alkali washing the toner base particles.

This application claims priority to Japanese application No. 2012-217617, filed on Sep. 28, 2012 and Japanese application No. 2013-034289, filed on Feb. 25, 2013, and incorporated herein by reference.

What is claimed is:

1. A toner comprising:
toner base particles, in each of which a colorant and a releasing agent are encapsulated with a binder resin, where the toner base particles are obtained by the method containing:
mixing and emulsifying a mixture containing the binder resin, the colorant, the releasing agent, and an organic solvent in an aqueous medium in the presence of resin particles,
wherein the aqueous medium contains a surfactant and an inorganic salt.

2. The toner according to claim 1, wherein the surfactant is contained in an amount of 0.1% by mass to 4.5% by mass relative to the aqueous medium.

3. The toner according to claim 1, wherein the surfactant is an anionic surfactant.

4. The toner according to claim 3, wherein the surfactant is alkyl sulfate or alkyl sulfonate.

5. The toner according to claim 1, wherein an amount of the inorganic salt used in the aqueous medium is 0.01% by mass to 20% by mass relative to the aqueous medium.

6. The toner according to claim 1, wherein the inorganic salt contains chloride, nitrate, sulfate, or carbonate of one inorganic material selected from the group consisting of Na, K, and Ca.

7. The toner according to claim 1, wherein an amount of the resin particles for use is in the range of 0.5 parts by mass to 5.0 parts by mass relative to 100 parts by mass of the toner.

8. The toner according to claim 1, wherein the binder resin contains a crystalline resin.

9. A method for producing a toner, comprising:
mixing and emulsifying a mixture containing a binder resin, a colorant, a releasing agent, and an organic solvent in an aqueous medium in the presence of resin particles, to form toner base particles in each of which the colorant and the releasing agent are encapsulated with the binder resin,
wherein the aqueous medium contains a surfactant and an inorganic salt.

10. The method according to claim 9, further comprising alkali washing the toner base particles.
